(19) United States
(12) Patent Application Publication
(10) Pub. No.: US 2014/0052524 A1
(43) Pub. Date: Feb. 20, 2014

(54) Systems and Methods for Providing Transaction Rewards

(71) Applicant: Robert Andersen, San Francisco, CA (US)

(72) Inventor: Robert Andersen, San Francisco, CA (US)

(21) Appl. No.: 13/911,039

(22) Filed: Jun. 5, 2013

Related U.S. Application Data
(60) Provisional application No. 61/656,450, filed on Jun. 6, 2012.

(51) Int. Cl. G06Q 30/02

(52) U.S. Cl. CPC G06Q 30/0226
USPC 705/14.27

(57) ABSTRACT

A computer-implemented method for processing a transaction between a user and a merchant comprises receiving a request from the user to conduct a transaction with the merchant. The request is received by a computer system programmed to facilitate the transaction. Next, with the aid of a processor of the computer system, the transaction between the user and the merchant is processed. A rewards database of the computer system is then updated with a record of the processed transaction. The rewards database includes a history of one or more transactions between the user and the merchant and a milestone that must be met for the user to be provided a reward from the merchant.

### CROSS-REFERENCE

This application claims priority to U.S. Provisional Patent Application Ser. No. 61/656,450, filed Jun. 6, 2012, which is entirely incorporated herein by reference.

### BACKGROUND

Consumers routinely make purchases using plastic credit or debit cards. Such plastic cards typically have magnetic stripes or chips that are encoded with information, such as a consumer's account information. A credit or a debit card may be used in a business transaction with a bank or creditor through use of a device that communicates with the bank or creditor, such as, for example an automated teller machine (ATM) or a credit card reader.

Credit cards having standard specifications can typically be read by point-of-sale devices at the location of a merchant. When the card is coupled to an electronic card reader at the merchant, such as a platform card reader, the electronic card reader may use its built-in communications interface to contact a creditor that handles credit authentication requests to process the transaction. The transaction may be finalized upon verification of the consumer's account information and the receipt of an approval signal from the creditor.

Despite the prevalence of systems and methods that implement point of sale transactions using plastic cards, plastic cards may prove problematic in situations in which a merchant does not accept payment using a plastic card or a communications link from the merchant to the creditor is inoperable.

### SUMMARY

An aspect of the present disclosure provides a computer-implemented method for providing merchants to a user, comprising providing, on a graphical user interface (GUI) of an electronic device of the user, a directory of one or more merchant cards, each merchant card having information of or related to a given merchant. Each merchant card from the one or more merchant cards can be configured to permit the user to initiate an electronic transaction with a merchant associated with the merchant card. At least one of the one or more merchant cards includes a widget that provides content that, with the aid of a computer processor, is generated in view of one or more merchant relevance criteria. The one or more merchant relevance criteria can be user specific. In an embodiment, the content provided by the widget is dynamically generated. In another embodiment, the method further comprises determining geolocation information of the user prior to providing the directory. The geolocation information can include a geographic location of the user. In another embodiment, in the directory, the one or more merchant cards are sorted based on the proximity of each merchant associated with each of the one or more merchant cards to the geographic location of the user. In another embodiment, the directory is sorted based on the relevance of each merchant associated with each of the one or merchant cards to the user. In another embodiment, the directory is filtered based on one or more criteria selected by the user. In another embodiment, the one or more merchant relevance criteria are selected from the group consisting of repeat transactions between the user and a merchant, the number of transactions between the user and a merchant, traffic conditions to the one or more merchants, and deals or promotions provided by the one or more merchants. In another embodiment, a merchant card from the one or more merchant cards is configured to permit the user to initiate an electronic transaction with a merchant associated with the merchant card if the user is within a given distance from the merchant.

In another aspect of the present disclosure, a computer-implemented method for providing merchants to a user comprises providing, on a graphical user interface (GUI) of an electronic device of the user, a directory of merchant cards, each merchant card having information of or related to a given merchant. With the aid of computer processor, based on one or more merchant relevance criteria, a subset of the merchant cards are rendered to be visually different than a remainder of the merchant cards. The one or more merchant relevance criteria can be user-specific. In an embodiment, the one or more merchant relevance criteria are selected from the group consisting of repeat transactions between the user and a merchant, the number of transactions between the user and a merchant, traffic conditions to the one or more merchants, and deals or promotions provided by the one or more merchants. In another embodiment, the subset of the merchant cards is rendered to have one or more different colors than the remainder of the merchant cards. In another embodiment, the subset of the merchant cards is rendered to have one or more different shapes than the remainder of the merchant cards. In another embodiment, a merchant card from the plurality permits the user to initiate an electronic transaction with a merchant associated with the merchant card. In another embodiment, the subset of the merchant cards is dynamically rendered to be visually different than the remainder of the merchant cards. In another embodiment, each merchant card in the directory is associated with a merchant that is within a given distance from a geographic location of the user. In another embodiment, the geographic location of the user is determined with the aid of a geolocation device of the user. In another embodiment, the directory is sorted based on the proximity of a merchant associated with a merchant card to the geographic location of the user. In another embodiment, the directory is sorted based on the relevance of each of the merchant cards to the user. In another embodiment, the directory is filtered based on one or more criteria selected by the user.

Another aspect of the present disclosure provides a computer-implemented method for searching for one or more merchants, comprising (a) determining geolocation information of a user; (b) conducting, with the aid of a computer processor, a search for at least merchant within a search area encompassing in whole or in part the geographic location of the user; and (c) displaying, on a graphical user interface (GUI) of an electronic device of the user, one or more merchants revealed upon the search in (b). The one or more merchants can be displayed on the GUI based on (i) the proximity of the user to each of the one or more merchants and (ii) the relevance of each of the one or more merchants to the user as determined from one or more merchant relevance criteria. The merchant relevance criteria can be user-specific. The geolocation information can include a geographic location of the user. In an embodiment, in (c), each of the one or more merchants is displayed to the user in a merchant card. In another embodiment, the one or more merchants are displayed in a list. In another embodiment, the list is sorted based on the proximity of the user to each of the one or more merchants and/or the relevance of the one or more merchants to the user. In another embodiment, the one or more merchant relevance criteria are selected from the group consisting of repeat transactions between the user and a merchant, the number of transactions between the user and a merchant, traffic conditions to the one or more merchants, and deals or promotions provided by the one or more merchants. In another embodiment, the one or more merchant relevance criteria are specific to the user. In another embodiment, the GUI enables the user to initiate an electronic transaction with a merchant displayed to the user in (c).

In another aspect of the present disclosure, a computer-implemented method for processing a transaction between a user and a merchant comprises (a) receiving a request from a user to conduct a transaction with a merchant, wherein the request is received by a computer system programmed to facilitate the transaction; (b) processing, with the aid of a computer processor of the computer system, the transaction between the user and the merchant; and (c) updating a rewards database of the computer system with a record of the transaction processed in (b). In some embodiments, an electronic punch card on a graphical user interface (GUI) of an electronic device of the user is updated (or visually rendered) to reflect the updated rewards database. The rewards database includes a history of one or more transactions between the user and the merchant and a milestone that must be met for the user to be provided a reward from the merchant. The milestone can be selected by the merchant, such as dynamically selected by the merchant or by the system in view of merchant preferences. In an embodiment, the method further comprises reviewing the rewards database, applying a reward to the transaction if the milestone is met, and, in (b), processing the transaction in view of the applied reward. In another embodiment, the merchant is at or in proximity of a geolocation of the user. In another embodiment, the geolocation is determined with the aid of a geolocation device of the user. In another embodiment, the request of (a) is received from an electronic device of the user. In another embodiment, the electronic device is a portable electronic device. In another embodiment, upon receiving the request in (a), the rewards database is accessed to identify the reward. In another embodiment, the computer system applies the reward to the transaction if the computer system determines that the milestone has been met. In another embodiment, the transaction is processed with the reward applied to the transaction. In another embodiment, the merchant is at or in proximity to a geolocation of the user. In another embodiment, the geolocation is determined with the aid of a geolocation device of the user. In another embodiment, the request is received from the geolocation device. In another embodiment, the method further comprises (d) displaying on an electronic device of the user the status of the reward based upon the rewards database updated in (c).

Another aspect of the present disclosure provides a computer-implemented method for providing a reward to a user in connection with a transaction between the user and a merchant, comprising updating a rewards database of a computer system with a record of a transaction between a user and a merchant, which rewards database includes a history of one or more transactions between the user and the merchant and a milestone that must be met for the user to be provided a reward from the merchant. The transaction is (i) initiated upon receiving, by a computer system programmed to facilitate the transaction, a request from the user to conduct the transaction with the merchant, and (ii) processed with the aid of a computer processor of the computer system. In an embodiment, the request is received from an electronic device of the user. In another embodiment, the electronic device is a portable electronic device. In another embodiment, upon receiving the request, the rewards database is accessed to identify the reward. In another embodiment, the computer system applies the reward to the transaction if the computer system determines that the milestone has been met. In another embodiment, the transaction is processed with the reward applied to the transaction. In another embodiment, the merchant is at or in proximity to a geolocation of the user. In another embodiment, the geolocation is determined with the aid of a geolocation device of the user. In another embodiment, the request is received from the geolocation device.

Another aspect of the present disclosure provides a computer-implemented method for processing a transaction between a user and a merchant, comprising displaying, on an electronic device of a user, a status of a record of one or more transactions with a merchant against a milestone that must be met for the user to be provided a reward from the merchant. The one or more transactions are (i) initiated upon receiving, by a computer system programmed to facilitate the transaction, a request from the user to conduct the transaction with the merchant, and (ii) processed with the aid of a computer processor of the computer system. In an embodiment, the request is received from the electronic device of the user. In another embodiment, the electronic device is a portable electronic device. In another embodiment, the status is displayed on the electronic device of the user upon updating a rewards database of the computer system with a record of a given transaction among the one or more transactions. In another embodiment, the rewards database includes a history of one or more transactions between the user and the merchant and the milestone. In another embodiment, upon receiving the request, the rewards database is accessed to identify the reward. In another embodiment, the computer system applies the reward to the transaction if the computer system determines that the milestone has been met. In another embodiment, the transaction is processed with the reward applied to the transaction. In another embodiment, the merchant is at or in proximity to a geolocation of the user. In another embodiment, the geolocation is determined with the aid of a geolocation device of the user. In another embodiment, the request is received from the geolocation device.

Another aspect of the present disclosure provides machine-executable code that, upon execution by one or more computer processors, implements any of the methods above or elsewhere herein.

Another aspect of the present disclosure provides a system comprising a memory location comprising machine-executable code implementing any of the methods above or elsewhere herein, and a computer processor in communication with the memory location. The computer processor can execute the machine executable code to implement any of the methods above or elsewhere herein.

In another aspect of the present disclosure, a system for searching for merchants comprises a computer processor and a computer memory location coupled to the computer processor. The computer memory location has machine-executable code, which, when executed by the computer processor, implements any of the methods above or elsewhere herein, alone or in combination. In an embodiment, the system further comprises a database for storing user loyalty information. In another embodiment, the system further comprises a database for storing user profile information. In another embodiment, the system further comprises a database for storing user transactional history data.

Another aspect of the present disclosure provides a system for maintaining a transaction reward between a user and a merchant. The system comprises a computer memory location having (i) a transaction record indicative of the number of transactions between the user and the merchant, and (ii) a milestone associated with a reward provided by the merchant, which reward is applied upon the milestone being met by the user. The system further comprises a computer processor coupled to the computer memory location. The computer processor applies a reward to a given transaction between the user and the merchant based upon a comparison between the transaction record and the milestone. In an embodiment, the computer processor is programmed or adapted to execute machine-readable instructions to implement a transaction between the user and the merchant. In another embodiment, the system is adapted to update an electronic punch card on a graphical user interface (GUI) of an electronic device of the user to reflect the status (e.g., completed, three out of five stars completed, etc.) of the reward. In another embodiment, the system is configured to (i) receive, from the user, a request to conduct a transaction with the merchant, (ii) notify the merchant of the request received from the merchant, and (iii) facilitate the transaction between the user and the merchant. In another embodiment, the system is configured to initiate the transaction between the user and the merchant if the user is within a given distance from the merchant. In another embodiment, the distance is based upon a determination of the geolocation of the user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the claimed invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” or “FIGS.” herein) of which:

FIG. 1 schematically illustrates a merchant directory, in accordance with an embodiment of the invention;

FIG. 2 schematically illustrates a system for facilitating methods of the disclosure, in accordance with an embodiment of the invention;

FIG. 3 schematically illustrates a transaction workflow in which user loyalty is applied to a given transaction, in accordance with an embodiment of the invention;

FIG. 4 schematically illustrates a loyalty redemption workflow in which a reward is applied to a given transaction, in accordance with an embodiment of the invention;

FIG. 5 schematically illustrates a transaction workflow in which a merchant requests the status of a reward from a server, in accordance with an embodiment of the invention;

FIG. 6 schematically illustrates a transaction workflow in which a server processes payment and updates an electronic punch card of a user, in accordance with an embodiment of the invention;

FIG. 7 schematically illustrates a transaction workflow in which a server updates an electronic punch card of a user and provides the user an updated punch card along with an electronic receipt of a given transaction, in accordance with an embodiment of the invention; and

FIGS. 8-25 show screenshots of graphical user interfaces (GUI's) of applications (apps) implemented on an electronic device, in accordance with various embodiments of the invention.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “merchant,” as used herein, generally refers to an individual, business or other entity, the occupation of which is the sale of goods for profit or, alternatively, trade of an item of value for another item of value. In an example, a merchant is a retail business or a shopkeeper. A merchant may be an online business or entity offering a product or service for profit of trade. Examples of merchants include, without limitation, food stores, grocery stores, electronic stores, department stores, bars, clubs, restaurants and book stores.

The term “user,” as used herein, generally refers to an individual or entity that uses systems and methods of the disclosure. A user can be an individual or entity that wishes to purchase a product or service of a merchant. A user can be a payer. In some situations, a user may be a merchant.

The term “widget,” as used herein, is an element in an application or web page that includes dynamic content. Widgets can take the form of on-screen device (clocks, event countdowns, auction-tickers, stock market tickers, flight arrival information, daily weather etc.).

The term “geographic location” (also “geo-location” and “geolocation” herein), as used herein, generally refers to the geographic location of an object, such as a user. A geolocation of a user can be determined or approximated using a geolocation device or system associated with the user, which may be an electronic device (e.g., mobile device) attached to or in proximity to the user. Geolocation information can include the geographic location of the object, such as coordinates of the object and/or an algorithm or methodology to approximate or otherwise calculate (or measure) the location of the object, and, in some cases, information as to other objects in proximity to the object. In some examples, geolocation information of a user includes the user's geographic location and/or the location of one or more merchants in proximity to the user. Geolocation information can include the relative positioning between objects, such as between users, or a payer and a merchant. In some cases, the geolocation of an object (e.g., user, electronic device) is not necessarily the location of the object, but rather the location that the object enters an area or structure, such as a building.

A geolocation device may be a portable electronic device (e.g., Apple® iPhone®, Android® enabled device). In some cases, the geolocation of an object can be determined using the manner in which a mobile device associated with the object communicates with a communication node, such as a wireless node. In an example, the geolocation of an object can be determined using node triangulation, such as, e.g., wireless node, WiFi node, satellite triangulation, and/or cellular tower node triangulation. In another example, the geolocation of a user can be determined by assessing the proximity of the user to a WiFi hotspot or one or more wireless routers. In some cases, the geolocation of an object can be determined using a geolocation device that includes a global positioning system (“GPS”), such a GPS subsystem (or module) associated with a mobile device (e.g., GPS capabilities of an Apple® iPhone® or Droid® based system).

In some situations, the geolocation of an object can be determined with the aid of visual and/or audio information captured by an electronic device of a user, such as, for example, images and/or video captured by a camera of the electronic device, or a peripheral device (e.g., Google® Goggles) coupled to the electronic device.

### Merchant Directories and Merchants Cards

In an aspect of the invention, a computer-implemented method for providing merchants to a user comprises providing, on a graphical user interface (GUI) of an electronic device of the user, a directory of one or more merchant cards, each merchant card having information of or related to a given merchant. In some cases, at least one of the one or more merchant cards includes a widget that provides, with the aid of a processor, content that is dynamically tailored in view of one or more user-specific relevance criteria (i.e., one or more relevance criteria that are specific to the user). Such one or more user-specific relevance criteria can be tailored to the user, for example, based on the user's transaction history with a merchant or multiple merchants. The directory can be provided on a GUI of an electronic device of the user. The device can be coupled to a system having a processor that is configured to execute machine-executable code to search for and provide merchants to the electronic device of the user, as described elsewhere herein.

A merchant card can be dedicated to a given merchant. In an example, a first merchant card is dedicated to a first merchant and a second merchant card is dedicated to a second merchant that is different from the first merchant. The first merchant card can have information that is only relevant to the first merchant and the second merchant card can have information that is only relevant to the second merchant. There can be a one-to-one correspondence between a merchant card and a merchant, though in some cases a merchant card can be dedicated to a plurality of merchants, such as a group of merchants.

A merchant card can permit a user to initiate and conduct an electronic transaction with a merchant associated with the merchant card. The electronic transaction can over a network, such as the Internet or an intranet. In some examples, a merchant card permits a user to open a tab with a merchant. The merchant card can permit a user to initiate

In some embodiments, the directory is continually updated based on the location of the user, which may be changing. The directory can be updated to provide merchant cards associated with merchants that are within a given distance from the user (e.g., within 1, 2, 3, 4, or 5 miles from the user), closest to the user (e.g., within 1 mile of the user), deemed most relevant to the user, or closest to the user and most relevant. In some examples, a merchant card in the directory is associated with a merchant that is within a distance that is selected by the merchant. The merchant in such a case may wish to conduct a transaction with the user if the user is within a distance from the merchant that is selected by the merchant. In some cases, the system can present the user with merchant cards of merchants that may not be the closest to the user, but may be more relevant to the user that merchants that may be closer to the user. In some cases, the directory is updated every 1 second or less, 2 seconds or less, 3 seconds or less, 4 seconds or less, 5 seconds or less, 6 seconds or less, 7 seconds or less, 8 seconds or less, 9 seconds or less, 10 seconds or less, 30 seconds or less, 1 minute or less, 2 minutes or less, 3 minutes or less, 4 minutes or less, 5 minutes or less, 10 minutes or less. Alternatively, the directory can be updated manually, such as upon request by the user. The directory can be updated in response to an event, such as, e.g., request by the user, request by a merchant, a new promotion, or a changed location of the user.

In some embodiments, geographic information of the user, such as geographic location of the user, is determined prior to providing the directory. In some embodiments, the content of the directory is based on a geographic location of the user. In some cases, the one or more merchant cards are sorted based on the proximity of each merchant associated with each of the one or more merchant cards to the geographic location of the user.

The geographic information of the user can be determined with the aid of a geolocation device of the user, which may be a portable electronic device. The geolocation device of the user can be used to initiate and conduct a transaction with the merchant. The geolocation device can have a graphical user interface (GUI) that enables the user to initiate the transaction with a merchant and process the transaction.

In some embodiments, the directory is sorted based on the relevance of each merchant associated with each of the one or merchant cards to the user. The relevance of each merchant to the user can be determined based on one or more relevance criteria. In some embodiments, the one or more relevance criteria can include number of transactions between the user and a merchant, number of transactions between the user and a type of merchant, number of transactions between the user and all merchants, traffic conditions to the one or more merchants, deals or promotions provided by the one or more merchants, the degree (or level) of interest for a particular merchant (e.g., The Coffee Spot) or particular type of merchant (e.g., a coffee shop, Indian food) from the user's transaction history, type of transaction involved, items involved in a transaction, types of merchants, quality of clicks on the merchant (e.g., click or finger tap on merchant card), content provided by merchant (e.g., quality of images), or other intelligence about payer behavior and/or merchant abilities to fulfill a payer's perceived need(s). In some cases, the one or more relevance criteria include the distance of the user from a merchant, such as the proximity of the user to the merchant. In other cases, the one or more relevance criteria do not include the distance of the user from a merchant. Relevance criteria can also include external data (e.g., weather, news, time of day, week, traffic conditions, etc.). Relevance criteria can include user predictive behavioral spending, which may be a function of user spending patterns over time. In some cases, the one or more relevance criteria include the distance of the user from a merchant, such as the proximity of the user to the merchant. In other cases, the one or more relevance criteria do not include the distance of the user from a merchant.

The directory can be filtered. In some examples, the directory is filtered based on one or more criteria selected by the user. Such criteria can include location, distance of a merchant associated with a merchant card from the user, type of merchant (e.g., restaurant, grocery store), and/or type of items offered by a merchant (e.g., coffee).

In some embodiments, merchant cards in the directory are ranked or otherwise sorted in view of the user's preferences, such as the user's merchant preferences (e.g., restaurant preferences), interests, item preferences, and/or other factors that may be relevant. For example, if the system determines that the user visits coffee shops on a given day of the week or a given time of the day, the user can rank coffee merchants higher in the directory than merchants that do not provide coffee.

Merchant card ranking can be based on one or more relevance factors, or, in some examples, the combination of one or more relevance factors and the user's geolocation information, such as the user's geographic location. Merchant cards can be ranked on the basis of a one or more relevance factors that are weighted in view of the user's proximity to merchants. In an example, a weighted relevance ranking may be obtained by multiplying a merchant's relevance, as may be determined based on one or more relevance criteria, by a factor that is inversely proportional to the user's proximity to the merchant. Merchant cards may then be ranked and provided for display by the user based on the weighted relevance ranking of each merchant card.

A merchant card can be selected to provide additional details on a given merchant, such as product or service details, costs associated with products and/or services of the merchant, the location of the merchant, directions to the merchant, hours of operation of the merchant, and promotions offered by the merchant. The user may select to open a tab with the merchant to initiate a process to purchase a product or service from the merchant.

In some embodiments, a directory can include 1 or more, 2 or more, 3 or more, 4 or more, 5 or more, 10 or more, 20 or more, 30 or more, 40 or more, 50 or more, 100 or more, or 1000 or more merchant cards.

A subset (e.g., some, nearly all) of the merchant cards can be rendered to be visually different than a remainder of the merchant cards. Such rendering can be dynamic, such as with changing location or time. In some examples, the subset of merchant cards can be rendered to have one or more different shapes and/or one or more different colors than the remainder of the merchant cards. As an alternative or in addition to one or more different color, other visual indicators may be used, such as a background image or shading. The subset of merchant cards can be visually rendered to be different than the remainder based on one or more relevance criteria.

For example, a first merchant card can have a bright orange color and the remainder of merchant cards can have a light gray color. The color can be the background color, a border color, or both. This can permit a user to readily distinguish the first merchant card from the remainder. As another example, the first merchant card can be rectangular and have a size that is larger than the sizes of the remainder of the merchant cards.

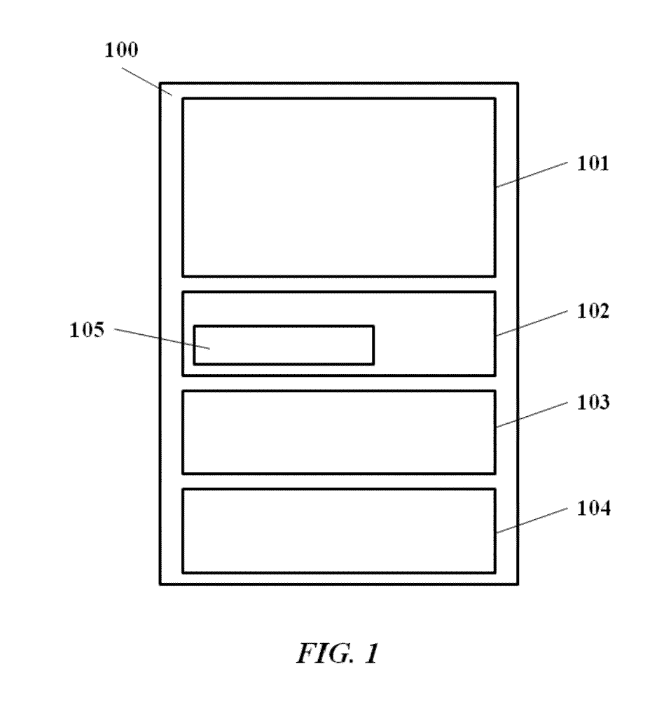

FIG. 1 shows a merchant directory 100, in accordance with an embodiment of the invention. The directory 100 may be provided on a GUI of an electronic device of the user. The device may be coupled to a system having a processor that is configured to execute machine-executable code to search for and provide merchants to the electronic device of the user.

With continued reference to FIG. 1, the directory 100 includes a first merchant card 101, second merchant card 102, third merchant card 103 and fourth merchant card 104. The first card 101 is dedicated to a first merchant, the second card 102 is dedicated to a second merchant, the third card 103 is dedicated to a third merchant, and the fourth card 104 is dedicated to a fourth merchant. Each merchant card may be rendered on the GUI for display on the electronic device of the user. The first merchant may be a featured merchant. In some cases, the featured merchant is determined by the system or the electronic device of the user to be most relevant to the user.

The second merchant card 102 includes a widget 105 with content that is dynamically tailored or otherwise generated in view of the one or more relevance criteria, as described elsewhere herein. The widget can provide merchant deals or promotions that are specific to the user. For example, the widget can provide the user a discount at a given merchant (e.g., “50% off at The Coffee Spot”), which discount is provided on a predetermined condition (e.g., the basis that the user is a repeat customer of the merchant).

The user can select any of the cards 101-104 to view addition detail on each respective merchant. In addition, the user can select any one of the cards 101-104 to purchase one or more products or services offered by a merchant. Such products may include items of value to the user, such as food items.

The merchant directory 100 provides various features that may be accessible via user gestures, as may be facilitated through the GUI on the display of the electronic device of the user. In some cases, the user can swipe a hand or finger of the user or other pointing device (e.g., computer mouse, touch pen) across a surface of the display and adjacent to a card in the directory 100 to access additional features that are specific to the card. For example, the user can swipe a finger (e.g., from left to right) across the second card 102 to access a bar that enables the user to open a tab at the second merchant, to select a merchant as a favorite merchant, to forward the merchant card (or a link to the merchant) to a designated recipient, or to contact the merchant. The user can swipe from left to right (or right to left) on a card (or widget) to reveal content. Each card can reveal different content upon a user swipe across the card. In some examples, the user can swipe along a first direction (e.g., top-to-bottom, bottom-to-top, diagonally from bottom to top, diagonally from top to bottom) to browse merchant cards, and swipe along a second direction that may be angled (e.g., orthogonal) to the first direction to view additional information about a given merchant. The user can swipe diagonally across a given merchant card.

In some cases, the cards 101-104 are ranked (or sorted) based on the user's loyalty with each merchant. In an example, a merchant for which the user is a repeat customer may appear at the top of the list, whereas a merchant for which the user has never visited may appear at the bottom of the list.

In some cases, the user may indicate the cards or merchants that the user prefers over other cards or merchants. For example, the user may “like” or “dislike” (or, alternatively, not select “like”) a given merchant. In some cases, the user selecting to view a card, or the frequency with which the user views cards, such as the frequency with which the user flips through a cards in carousel view, can indicate a preference for a card. The system can learn, based on the user's merchant or card preferences, which merchants the user prefers, and provide the user with merchants that meet the user's preferences. Such preferences may be determined based on a profile of the user, such as user likes and preferences, as may be provided in a profile of the user.

The look and feel of a merchant card can be tailored based on user-specific merchant relevance criteria. In some embodiments, a computer-implemented method for providing merchants to a user comprises providing, on a graphical user interface (GUI) of an electronic device of the user, a directory of merchant cards, each merchant card having information of or related to a given merchant. Based on one or more user-specific merchant relevance criteria, a subset of the merchant cards are rendered to be visually different than a remainder of the merchant cards.

In some cases, the shape or color of one card may be selected to make it more or less appealing to a user than another card. Such modification may be made to increase the likelihood of the user selecting one card over another. For example, the second card 102 can be provided in a color that is more appealing to the user (based on the user's preferences) than the third card 103. Such modification may be made, for example, if the user is a repeat customer at the second merchant and not the third merchant.

The directory 100 may be viewed in list view (as shown) or carousel view, in which the user can review additional information about a merchant and peruse other merchants with the aid of gestures. The user may elect to save certain merchant cards for future use or view. In some examples, the system (or server) receives an indication from a user selecting certain merchant cards, and in response, the system saves certain merchant cards for later view or use by the user. In some cases, merchant cards can be ranked and displayed based on distance, or whether merchants have recent offers or other promotional deals or incentives for the user. If the user is in close proximity to a merchant to make a payment, the merchant card may provide the user the opportunity to make a payment (e.g., the card has an “open tab” widget), and may have information that is focused on enabling the user to make a payment. In some examples, the system, upon determining the proximity of the user to a merchant, provides the user information that is focused on enabling the user to make a payment. If the user is not in close proximity to the merchant to make a payment, the merchant card can display dynamic information to give the user a reason or incentive to visit the merchant (e.g., “10% off your purchase”).

### Relevance Ranking and Sorting

Another aspect of the invention provides a computer-implemented method to enable a user to search for one or more merchants. The search can be conducted with the aid of a system having a processor that executes machine-readable instructions for implementing the search, as described elsewhere herein. The method comprises conducting a search for at least one merchant within a search area encompassing in whole or in part a designated geographic location. In some embodiments, the designated geographic location is the geographic location of the user as determined with the aid of a geolocation device. Alternatively, the designated geographic location is a location selected by the user, which may not necessarily be the geographic location of the user.

Next, one or more merchants revealed upon the search are provided on a graphical user interface (GUI) of an electronic device of the user. The one or more merchants can be provided on the GUI based on (i) the proximity of the user to each of the one or more merchants and (ii) the relevance of each of the one or more merchants to the user as determined from one or more relevance criteria.

The one or more relevance criteria can be specific to the user (also “user-specific” herein). The relevance criteria can include: number of transactions between the user and a merchant, number of transactions between the user and a type of merchant, number of transactions between the user and all merchants, traffic conditions to the one or more merchants, deals or promotions provided by the one or more merchants, the degree (or level) of interest for a particular merchant (e.g., The Coffee Spot) or particular type of merchant (e.g., a coffee shop, Indian food) from the user's transaction history, type of transaction, items involved in transactions, types of merchants, traffic conditions to the one or more merchants, and deals or promotions provided by the one or more merchants, quality of clicks on the merchant (e.g., clicks on merchant card), content provided by merchant (e.g., quality of images), or other intelligence about payer behavior and/or merchant abilities to fulfill a payer's perceived need(s). Relevance criteria can also include external data (e.g., weather, news, time of day, week). Relevance criteria may include user predictive behavioral spending, which may be a function of user spending patterns over time. In some cases, the one or more relevance criteria include the distance of the user from a merchant, such as the proximity of the user to the merchant. In other cases, the one or more relevance criteria do not include the distance of the user from a merchant.

In some embodiments, the one or more relevance criteria are at least in part dependent on the user's preferences, such as the user's merchant preferences (e.g., restaurant preferences), interests, item preferences, and/or other factors that may be relevant. For example, if the system determines that the user visits coffee shops on a given day of the week or a given time of the day, the user may rank coffee merchants higher in the directory than merchants that do not provide coffee.

The one or more merchants, as provided on the GUI, may be ranked or sorted based on the relevance of each merchant to the user. The relevance can be determined based on the one or more user-specific relevance criteria. The relevance may be determined following a determination of the distance of the merchant from the user. In some examples, however, the relevance is determined separately from the distance of the user from the merchant.

The one or more merchants can be provided in a list on the GUI. The list can include merchant cards. A merchant card can have various shapes and sizes. A merchant card can be circular, triangular, square, rectangular, pentagonal, hexagonal, octagonal, heptagonal, or nonagonal, or partial shapes and/or combinations thereof, such as semi-circular. A merchant card can be pseudo-three dimensional. A pseudo-three dimensional card can have a cross-section that is circular, triangular, square, rectangular, pentagonal, hexagonal, octagonal, heptagonal, or nonagonal, or partial shapes and/or combinations thereof, such as semi-circular. In an example, a merchant card is square or rectangular.

In some embodiments, a merchant card includes information of or related to a merchant, such as, for example, the name of the merchant, the distance of the user from merchant (e.g., 1 mile), the distance of a location selected by the user from the merchant, and any deals or promotions provided by the merchant. The deals or promotions may be specific to the user. In an example, a merchant provides the user a deal that is based on the user not having previously transacted with the merchant.

A merchant card may include a widget, the content of which is dynamically tailored in view of the one or more relevance criteria. For example, the widget can provide merchant deals or promotions that are specific to the user, not specific to the user, or a combination of deals or promotions that are specific and not specific to the user. For example, the widget can provide the user a discount at a given merchant, which discount is provided on the basis that the user is a repeat customer of the merchant.

In some embodiments, the one or more merchants are provided on the GUI in a list that is sorted based on the distance of the user from each of the one or more merchants and/or the relevance of the one or more merchants to the user. In some cases, the list can be sorted based on the proximity of the user to each of the one or more merchants. In an example, merchants that are close to the user are presented towards the top of the list, and other merchants can appear on the list in descending order based on proximity to the user.

### Systems for Facilitating Transactions

Another aspect of the invention provides a system that is configured implement the methods of the disclosure. The system can include a computer server (“server”) that is operatively coupled to an electronic device of a user and an electronic device of a merchant.

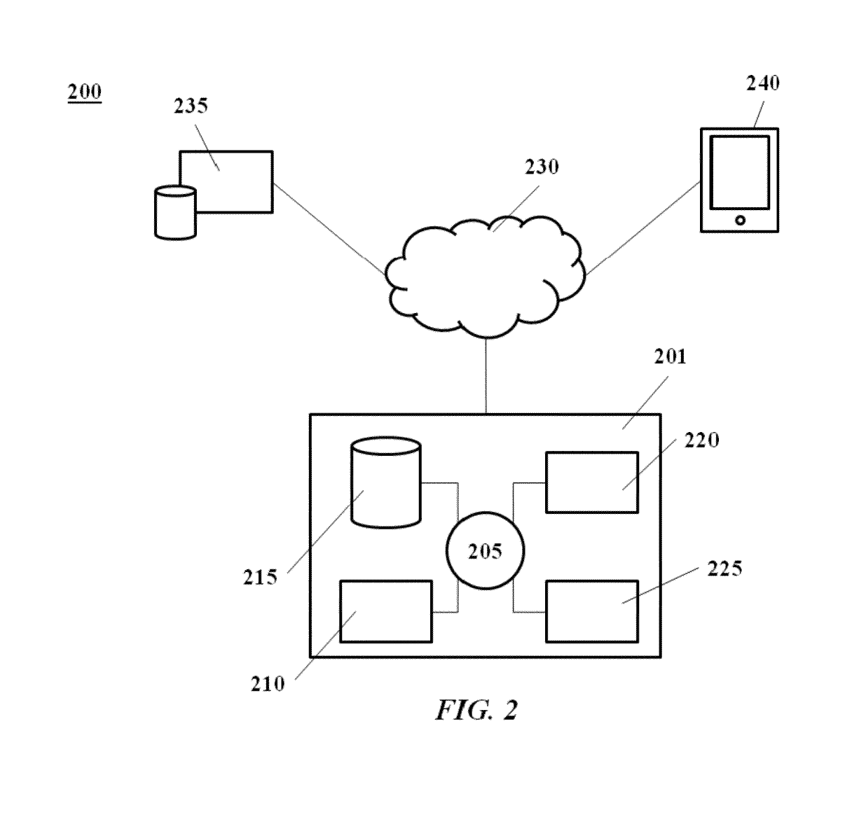

FIG. 2 shows a system 200 adapted to enable a user to search for merchants, in accordance with an embodiment of the invention. The system 200 includes a central computer server (“server”) 201 that is programmed to implement exemplary methods described herein. The server 201 includes a central processing unit (CPU, also “processor” and “computer processor” herein) 205, which can be a single core or multi core processor, or a plurality of processors for parallel processing. The server 201 also includes memory 210 (e.g., random-access memory, read-only memory, flash memory), electronic storage unit 215 (e.g., hard disk), communications interface 220 (e.g., network adapter) for communicating with one or more other systems, and peripheral devices 225, such as cache, other memory, data storage and/or electronic display adapters. The memory 210, storage unit 215, interface 220 and peripheral devices 225 are in communication with the CPU 205 through a communications bus (solid lines), such as a motherboard. The storage unit 215 can be a data storage unit (or data repository) for storing data. The server 201 is operatively coupled to a computer network (“network”) 230 with the aid of the communications interface 220. The network 230 can be the Internet, an internet and/or extranet, or an intranet and/or extranet that is in communication with the Internet. The network 230 in some cases is a telecommunication and/or data network. The network 230 can include one or more computer servers, which can enable distributed computing, such as cloud computing. The network 230 in some cases, with the aid of the server 201, can implement a peer-to-peer network, which may enable devices coupled to the server 201 to behave as a client or a server.

The storage unit 215 can store files, such as filed related to merchant profiles and/or accounts, and user profiles. The server 201 in some cases can include one or more additional data storage units that are external to the server 201, such as located on a remote server that is in communication with the server 201 through an intranet or the Internet.

The storage unit 215 can store user and merchant transactional information. The storage unit 215 can store user transactional information, which can include, without limitation, merchants from which the user has purchased products and/or services, the number of times the user has used a merchant, the frequency with which the user purchases products and/or services from a merchant, the types of merchants from which the user purchases products and/or services. The data storage unit 215 may include user loyalty information, such as the number of times the user has purchased products and/or services from a given merchant. User loyalty information may be coupled with loyalty criteria from a merchant, which criteria, when met or otherwise satisfied, may enable the merchant to offer the user certain products or services, such as a discounted product or service, or a complimentary product or service.

The server 201 can communicate with one or more remote computer systems through the network 230. In the illustrated example, the server 201 is in communication with a first computer system 235 and a second computer system 240 that are located remotely with respect to the server 201. In the illustrated example, the first computer system 235 is a merchant computer system that may have a database for recording transaction data, and the second computer system 240 is a user computer system, such as a computer system of a potential purchaser of a service or product of the merchant. The first computer system 235 and second computer system 240 can be, for example, personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants.

In an example, the second computer system 240 is a portable electronic device of a user that desires to search for and find merchants at or in proximity to a geolocation of the user. The user can access the server 201 via the network 230 to request the search. The server 201 can conduct the search and transmit search results to the second computer system 240 of the user. The search results can be displayed on a graphical user interface of the second computer system 240. In some cases, both the first computer system 235 and the second computer system 240 have a geolocation.

In some situations the system 200 includes a single server 201. In other situations, the system 200 includes multiple servers in communication with one another through an intranet and/or the Internet.

The server 201 can be adapted to store user profile information, such as, for example, a name, physical address, email address, telephone number, instant messaging (IM) handle, educational information, work information, social likes and/or dislikes, products likes and/or dislikes, merchant preferences, favorites types of merchants (e.g., restaurants preferred over bars) and historical information of past transactions of the user (which may be transactions made using the system 200), and other information of potential relevance to the user or other users. Such profile information can be stored on the storage unit 215 of the server 201.

Methods as described herein can be implemented by way of machine (or computer processor) executable code (or software) stored on an electronic storage location of the server 201, such as, for example, on the memory 210 or electronic storage unit 215. During use, the code can be executed by the processor 205. In some cases, the code can be retrieved from the storage unit 215 and stored on the memory 210 for ready access by the processor 205. In some situations, the electronic storage unit 215 can be precluded, and machine-executable instructions are stored on memory 210. Alternatively, the code can be executed on the second computer system 240 of the user.

The code can be pre-compiled and configured for use with a machine have a processer adapted to execute the code, or can be compiled during runtime. The code can be supplied in a programming language that can be selected to enable the code to execute in a pre-compiled or as-compiled fashion.

Aspects of the systems and methods provided herein, such as the server 201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

In some cases, the server 201 can be configured for data mining, extract, transform and load (ETL), or spidering (including Web Spidering where the system retrieves data from remote systems over a network and access an Application Programmer Interface or parses the resulting markup) operations, which may permit the system to load information from a raw data source (or mined data) into a data warehouse. The data warehouse may be configured for use with a business intelligence system (e.g., Microstrategy®, Business Objects®). The media file management system can include a data mining module adapted to search for media content in various source locations, such as email accounts and various network sources, such as social networking accounts (e.g., Facebook®, Foursquare®, Google+®, Linkedin®) or on publisher sites, such as, for example, weblogs.

The results of a user-initiated search for merchants can be presented to a user with the aid of a user interface (UI), such as a graphical user interface (GUI), on an electronic device of the user. In some situations, a GUI can enable a user to access the results of a search for entertainment events at a designated geographic.

The UI, such as GUI, can be provided on a display of an electronic device of the user that is adapted to provide geolocation information of the user, such as, for example, measure (or calculate) the geolocation of the user. The display can be a capacitive or resistive touch display, or a head-mountable display (e.g., Google® Goggles). Such displays can be used with other systems and methods of the disclosure.

Methods of the disclosure may be facilitated with the aid of applications (apps) that can be installed on electronic devices of users. An app can include a GUI on a display of the electronic device of the user. The app can be configured to perform certain functions of the system, such as, for example, permitting a user to initiate a transaction with a merchant if the user is within a given distance from the merchant. In an example, if the user is within a given distance from the merchant, the app can permit the user to request to initiate a transaction with the merchant, which request is directed to the system. The system can then inform the merchant that the user desires to initiate a transaction with the merchant, and the transaction can be subsequently processed with the aid of the system, as described elsewhere herein.

Systems of the disclosure may include both payer and merchant data. This advantageously permits a system to determine relevance ranking that may be user specific and directed at select one or more merchants or types of merchants. The system may be owned and/or operated by a single entity.

In some cases, the merchant and/or payer information may be stored in a memory location of the system. Accordingly, relevance ranking may be a function of both payer and merchant information. For instance, a merchant may intent to target payers of a given age group. In some cases, a search for merchants by a payer may provide merchants that consider the payer to be relevant to the merchants.

### Loyalty and Reward Redemption

Another aspect of the invention provides systems and methods for loyalty and reward redemption. The method can be facilitated with the aid of systems provided herein, such as the system 200 of FIG. 2. Systems of the disclosure can be programmed to maintain a record of user (e.g., payer) transactions with a given merchant and provide an item of value of benefit to the user based on the record. The system can provide an item of benefit if one or more conditions are satisfied (e.g., conditions that are spend based, visit based, etc.). For example, a repeat payer of a merchant can be provided a discount on select purchases. In addition, systems of the disclosure can be programmed to maintain a record of rewards, which rewards may be provided to users. For example a first-time payer of a merchant may be provided a discount on a given purchase. The discount may be provided to incentivize the payer to purchase products or services from the merchant.

In some embodiments, a method for processing a transaction between a user and a merchant comprises receiving a request from the user to conduct a transaction with the merchant. The user may wish to purchase a product or service from the merchant. The request can be received by a computer system (e.g., the system 200 of FIG. 2) programmed to facilitate the transaction. Next, with the aid of one or more processors of the computer system, the transaction between the user and the merchant is processed. This can involve initiating the transaction and facilitating the transaction between the user and the merchant, as described elsewhere herein. A reward can be applied to the transaction if a milestone is met. Next, a rewards database of the computer system is updated with a record of the transaction processed by the computer system. The rewards database can include a history of one or more transactions between the user and the merchant and the milestone that must be met for the user to be provided a reward from the merchant.

In some cases, the request can be received from an electronic device of the user, such as a portable electronic device. The portable electronic device can include a user interface (UI), such as a graphical user interface (GUI), which can enable the user to initiate the transaction between the user and the merchant and to view the status of any rewards the user has with the merchant, as well as any promotions offered by the merchant to the user.

In some cases, upon receiving the request, the computer system accesses the rewards database in order to identify the reward. The computer system applies the reward to the transaction if the computer system determines that the milestone has been met. The transaction is then processed with the reward applied to the transaction.

The merchant can be at or in proximity to a geolocation of the user. The geolocation can be determined with the aid of a geolocation device of the user. In some cases, the request is received by the computer system from the geolocation device of the user.

In some situations, the status of the reward is displayed on the electronic device of the user. The status of the reward can be displayed on the UI, such as the GUI, of the electronic device. In some examples, the status of the reward can be presented based on the record (or history) of one or more transactions between the user and the merchant, which can be displayed against a milestone that must be met for the user to be provided a reward from the merchant. For example, the GUI of the electronic device of the user can show an electronic punch card, as described elsewhere herein.

In some embodiments, electronic transactions are integrated with loyalty and/or reward programs. Systems of the disclosure can be configured to integrate payer loyalty features with transactions that are facilitated by the systems. For example, a system that facilitates an electronic transaction between a user (or payer) and a merchant can maintain an electronic punch card that keeps a record of user purchases that qualify for loyalty points. The accrual of loyalty points may qualify the user for certain benefits from the merchant.

In some cases, a system maintains a record of user transactions with a given merchant. Rewards or loyalty-based benefits can be provided on the basis of the user's history with the merchant. Alternatively, the system can maintain a record of user transactions with a given type of merchant. Rewards or loyalty-based benefits can be provided on the basis of the user's history with merchants that are included with the given type of merchant. For example the user may be provided certain benefits for buying products from coffee stores or specific merchants, such as, e.g., Starbucks®. Such benefits may be provided by the system.

Some embodiments provide a computer-implemented method for processing a transaction between a user and a merchant comprises receiving a request from a user to conduct a transaction with a merchant, and processing, with the aid of a processor, the transaction between the user and the merchant. A rewards database is then updated with a record of the processed transaction. The rewards database includes a history of one or more transactions between the user and the merchant and a milestone that must be met for the user to be provided a reward from the merchant. The method can be implemented using computer systems of the disclosure, such as the server 201 of FIG. 2.

Rewards can be tied to different types of milestones. Milestones can be selected from a requisite number of items purchased, one or more types of items purchased, valued of items purchased, total amount spent at a given merchant, and combinations of items and/or services purchased. The milestones can be selected by the merchant. For example, the merchant can specify one or more items or services that must be purchased or otherwise involved in the transaction (e.g., traded), and/or an amount that must be spent, to meet a milestone. In some cases, the merchant can specific a combination of milestones that must be satisfied in order for the user (or payer) to receive a given reward from the merchant. Various types of rewards can be provided by a merchant. The types of rewards can be dynamically selected in view of merchant preferences or relevance criteria, as described elsewhere herein. A merchant can provide various rewards, such as a free item or service, a discounted item or service, or a percentage reduction of a given transaction. Loyalty rewards may be subject to merchant control. The merchant can select one or more milestone criteria and/or the type of reward. The system can suggest one or more milestone criteria to the merchant, which can be a function of the merchant's type of business, items offered for purchase, services offered, and/or payer-specific information (e.g., items purchased by the payer, the payer's age or sex, etc.).

A reward milestone can be tailored to a merchant (i.e., merchant-specific). A first merchant of a given type (e.g., coffee store) can have a different reward and/or reward milestone(s) than a second merchant of the given type. In an example, a first coffee store offers a free cup of coffee after a purchase of five cups of coffee by a payer, while a second coffee store offers a free pastry after a purchase of ten pastries by the payer.

In some cases, the method further comprises reviewing the rewards database and applying a reward to the transaction if the milestone is met. The transaction is then processed in view of the applied reward. For example, if the user has met a requisite number of drink purchases for a free or discounted drink, the server can apply a reward (e.g., drink discount or free drink) prior to consummating the transaction between the user and the merchant.

In some cases, the merchant is at or in proximity of a geolocation of the user. The geolocation can be determined with the aid of a geolocation device of the user.

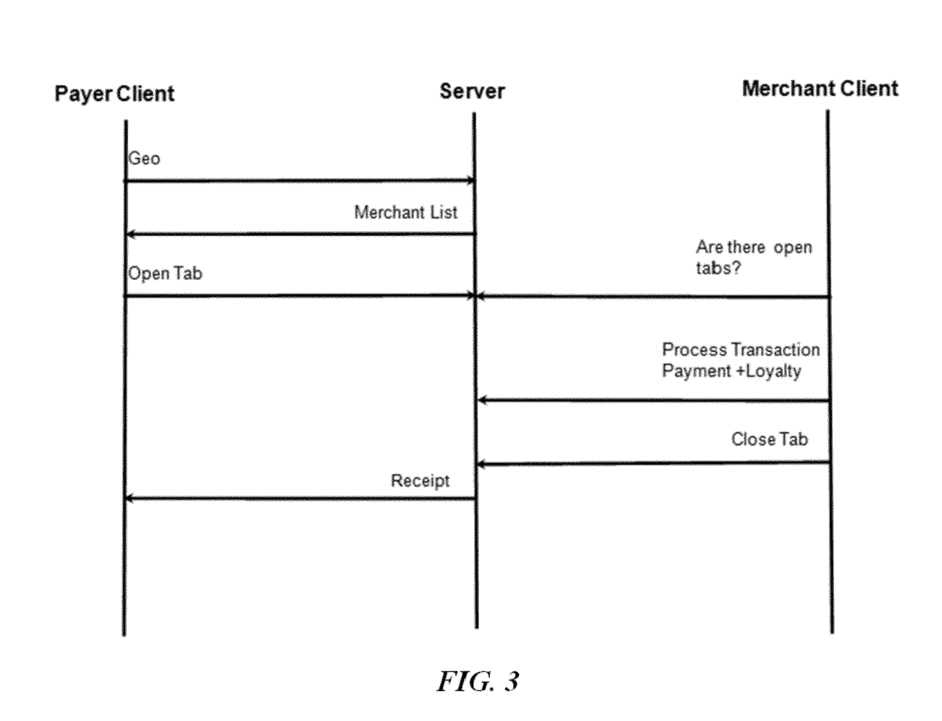

FIG. 3 shows a loyalty redemption method (or work-flow), in accordance with an embodiment of the invention. The method is implemented upon the communication between a user's electronic device, a computer server (“Server”), and a merchant's electronic device. The user in such a case is a payer that desires to make a transaction with the merchant. The user's client (“Payer Client”) can be an electronic device, such as a portable electronic device, that is configured to communicate with the Server. The merchant's client (“Merchant Client”) can be a computer system that is configured to communicate with the Server. The computer system can include one or more computers, each of which can include one or more processors for executing machine-readable code to implement a transaction.

Initially, the geolocation of the Payer Client is determined, which may be the geolocation of the payer, and directs geolocation information to the Server. Next, the Server provides the Payer Client a list of merchants based on one or more geolocation criteria of the user, Server and/or the merchant. The Server may provide the Payer Client a list of merchants that are at or in proximity to the user's geolocation. Next, the payer selects to initiate a transaction with a given merchant from the list of merchants. In some cases, the payer may wish to open a tab for the payer with the merchant. Upon the payer indicating in the Payer Client that the payer wishes to open a tab with the merchant, the Payer Client direct the request to open the tab to the Server. The Payer Client can transmit to the Server an indication to open a tab associated with an account of the payer, reflecting an indication of the payer's consent to perform a cardless payment transaction with the merchant. The Merchant Client can send a request to the Server for a list of open tabs (e.g., a list of payer user accounts from which the Server has received indication of consent to enter into a cardless payment transaction). The Merchant Client processes the transaction and provides transaction information along with any loyalty factors to the Server. In some cases, the transaction can be processed by the Server. In an example, if the payer is a repeat customer of the merchant, the merchant can provide the user a discount. Such loyalty factors can be maintained in a database of the Server or the Merchant Client. Next, the Merchant Client provides an indication to close the tab associated with the transaction and the Server transmits an electronic receipt for the payer, which can include any loyalty updates (e.g., electronic punch card updates). The workflow of FIG. 3 can be suited for cardless payment transactions.

In some embodiments, the payer accrues loyalty points upon the user completing a transaction and accepting an electronic receipt from the system. Loyalty points (e.g., punches in a punch card) can be provided upon the system completing a given transaction. Merchants can specify conditions a payer should satisfy to receive loyalty points (e.g., punches in a punch card, repeat visits, spend requirements, etc.).

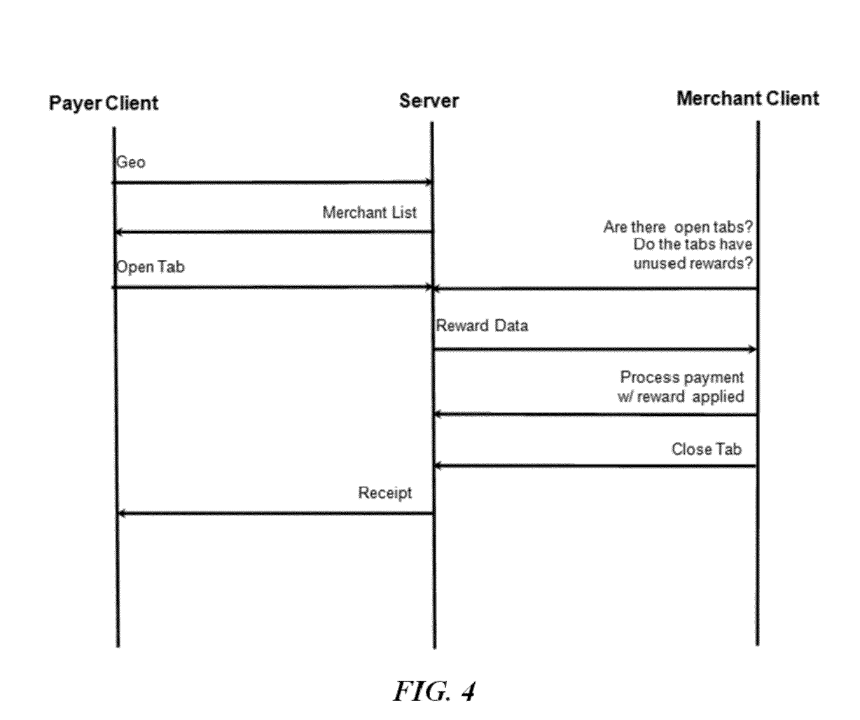

In some cases, rewards may be included in a transaction between a user and a merchant. With reference to FIG. 4, in an embodiment, the Payer Client, upon receiving a Merchant List form the Server and selecting the merchant, requests to open a tab with the merchant by providing indication to open a tab associated with an account of the payer user. The indication reflects the payer's consent to perform a cardless payment transaction with the merchant. The Merchant Client can send a request to the Server for a list of open tabs (e.g., a list of payers from which the Server has received indication of consent to enter into a payment transaction for the merchant) and a request for information relating to whether any of the tabs have unused rewards. The Server can determine whether the open tab account associated with the payer has any unused rewards with the merchant. In other examples, such determination can be made at the Merchant Client. For instance, the Server can include a rewards database that includes payer transactional data and a rewards history. The Server can update the payer's rewards history based on one or more rewards criteria supplied by the merchant, which criteria can include a free product or service upon a given number of purchases at the merchant (e.g., the payer shall receive one free drink upon purchasing ten drinks), or the proximity of the payer to the merchant. In some cases, upon the payer requesting to open a tab with the merchant to purchase a product or service provided by the merchant, the Server or the merchant can determine whether the payer is eligible to use a reward in the transaction. In FIG. 4, the Server supplies reward data to the merchant. If the user is eligible to use a reward, the merchant can process payment with the reward applied and provides transaction information (e.g., payment and reward applied) to the Server for further processing. Next, the Merchant Client can provide instruction to the Server to close the tab associated with the payer. The Server can then direct or otherwise provide an electronic receipt to the Payer Client. In some cases, the workflow of FIG. 4 may be suited for cardless payment transactions.

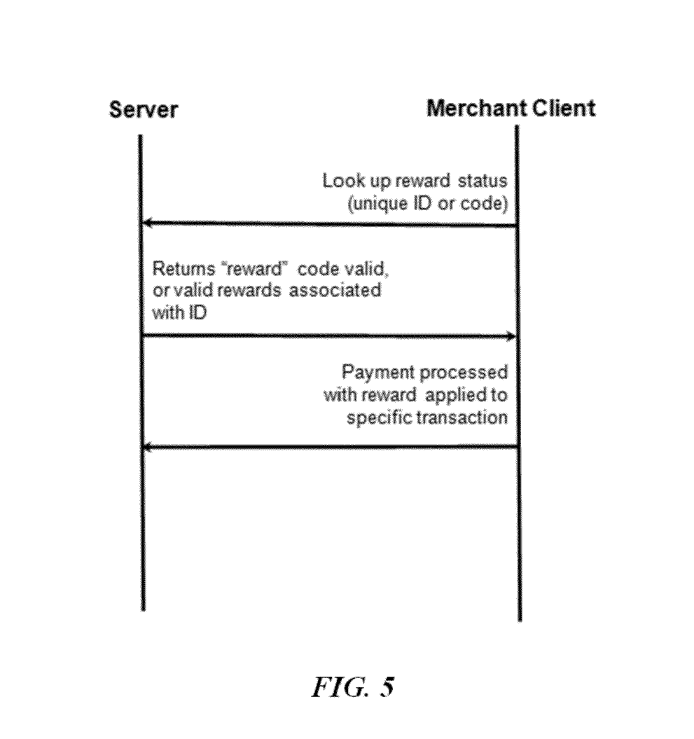

In some embodiments, a merchant can determine whether a payer has a valid reward prior to applying any reward to a transaction. With reference to FIG. 5, prior to the merchant finalizing a transaction with a payer, the Merchant Client contacts the Server to determine the status of the payer's reward at the merchant. For example, if the merchant will provide the payer a free product upon the purchase of five products from the merchant, the merchant can contact the Server to determine whether the payer has purchased five products from the merchant. In some cases, the Merchant Client directs a unique identification code or number, or other identifier that is uniquely associated with the payer, to the Server. The Server then determines whether the payer has a valid reward and transmits to the Merchant Client an indication that the payer's reward is valid or invalid, or, in some cases, provides the Merchant Client a valid reward associated with the payer. Next, the Merchant Client processes payment with reward applied to the transaction and sends the transaction information to the Server.

The workflow of FIG. 5 may be implemented in cash or card transactions, or cardless transactions. Cardless transactions can include transactions facilitated with the aid of systems provided herein, such as the system 200 of FIG. 2. In an example, in a cardless scenario a server facilitating a transaction between a payer and merchant, such as the server 201 of FIG. 2, provides funds to the merchant and receive funds from the payer.

In an example, at the point of sale the merchant is provided a reward card from the payer, and the Merchant Client contacts the Server to determine whether the reward card is valid and/or whether the payer has any rewards that may be applied to a given transaction. Alternatively, the Merchant Client may request reward information from the Server, and the Server can provide that information to the Merchant Client. The Merchant Client can then determine whether the payer has rewards to be applied to the transaction.

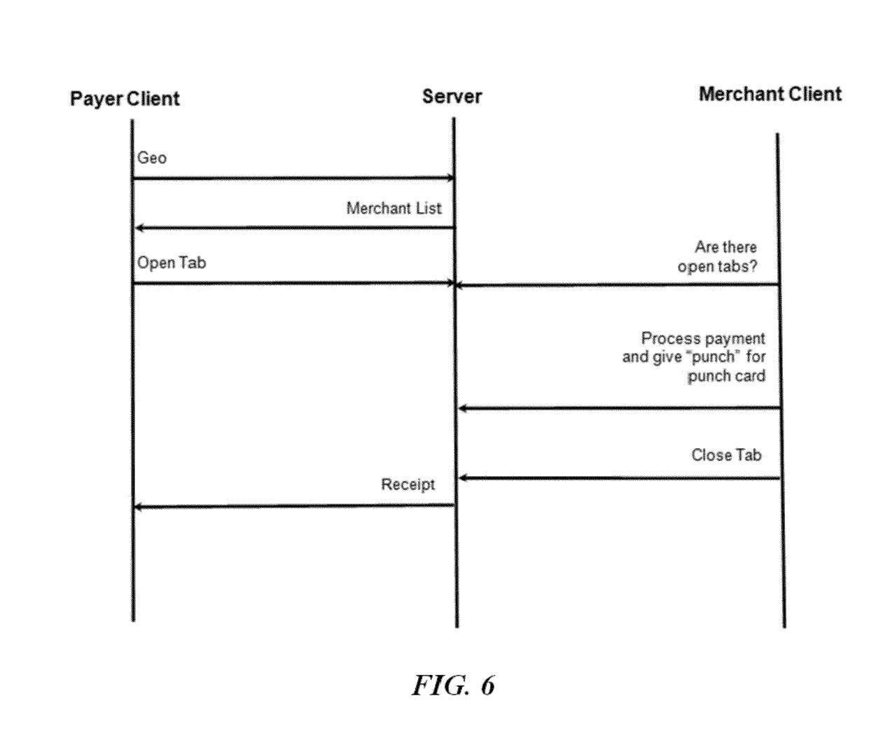

In some embodiments, the payer and merchant can maintain a record of transactions. The record can be used to determine whether rewards can be applied to a given transaction. With reference to FIG. 6, upon the Merchant Client processing a payment with the Server for a given transaction with the Payer Client of the payer, a rewards record of the payer is updated to reflect the transaction. The rewards record can be spending based, visit based, etc. In some cases, the rewards record is an electronic punch card, and upon the Server processing payment, the rewards record is updated by including an additional electronic punch in the punch card. The rewards record can be updated by the Merchant Client, which can subsequently direct an indication of the updated rewards card to the Server, or, alternatively, the rewards record can be updated by the Server.

A reward can be selected by a merchant. For example, a merchant can select a product or service to offer a payer upon the payer meeting a milestone, such as a number of product purchases. The milestone can be selected by the merchant.

A rewards record can be created, updated or otherwise maintained in a database of the Server, such as for example, the storage unit 215 of the server 201. Alternatively, the database can be located on the Merchant Client, or a system associated with the Merchant Client. In an example, a rewards record can include a database column that includes a requisite limit (or milestone) that a payer must meet in order for the payer to be provided a reward. The rewards record can also include a database column that includes a reward number that is incremented upon successive purchases. Upon request from the Merchant Client, the Server can compare the reward number to the limit to determine whether a reward may be provided to the payer. In some cases, a rewards record is updated only if one or more rewards criteria (e.g., minimum spending amount) are met. The one or more rewards criteria may be selected by the merchant.

A rewards record can be an electronic punch card, which punch card can keep a record of the number of transactions conducted that meet one or more rewards criteria, and a requisite milestone that must be met in order for the payer to be given a reward.

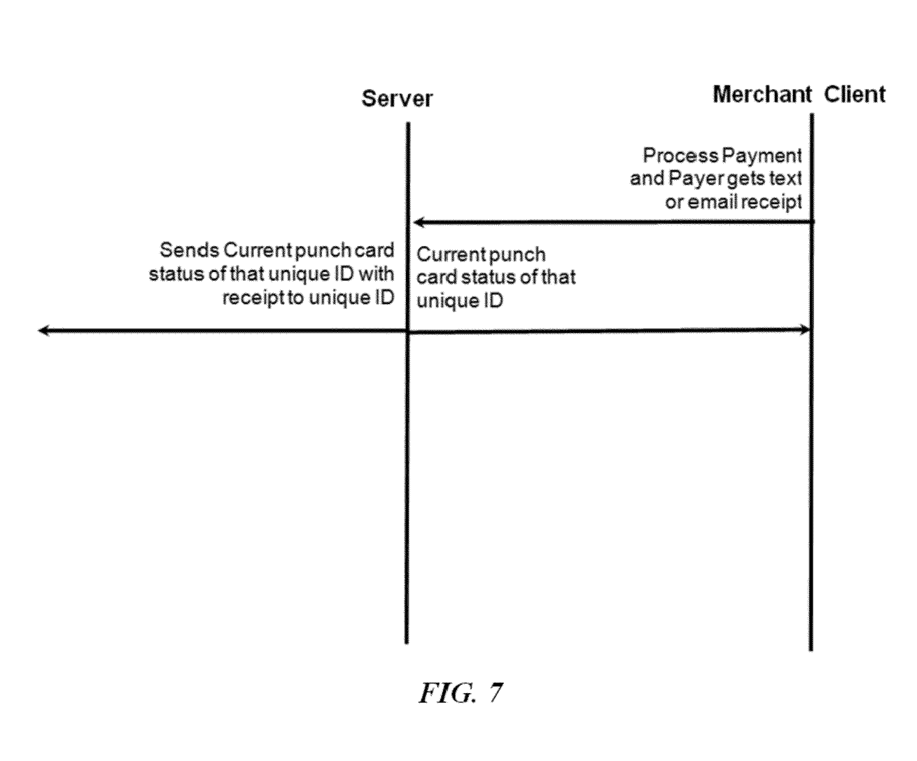

In some cases, upon the Server processing a transaction between a merchant and a payer, the Server provides the Payer Client an electronic receipt of the transaction and an update on any rewards the payer may have with the merchant. With reference to FIG. 7, the Merchant Client instructs the Server to process payment associated with a given transaction with the payer. The Server processes payment and provides the payer an electronic receipt of the transactions, along with a status of the payer's punch card with the merchant. The electronic receipt and punch card may be provided to the payer via an electronic message, such as instant message, short-message service (SMS) text message, multimedia message service (MMS) text message, or electronic mail (“email”), or a message or other notification that is specific to the application implementing the transaction on the Payer Client (e.g., a device application, or “app”). In some cases, GUI of an electronic device of the payer can be updated with information to reflect the transaction. In some situations, a merchant card on a GUI of the payer (or user) is updated to reflect the transaction, to provide a reward status (e.g., one purchase remaining until the payer is provided a free product), or both.

In some embodiments, the Merchant Client is configured to search for open tabs and select payers to engage in transactions or decline invitations to engage in transactions with some payers. The Merchant Client can enable the merchant to view open tabs and provide rewards, promotions or deals to a payer based on one or more criteria selected by the merchant, such as, for example, whether the payer is a repeat customer of the merchant, and/or whether the payer is in proximity to the merchant. In an example, if the payer is adjacent to a geolocation of the merchant, the Merchant Client (or the Server) may provide the payer a promotion or deal to open a tab and make a purchase from the merchant. In some situations, the merchant can manually provide the payer a reward, promotion, or deal.

Some embodiments provide a system for maintaining a transaction reward between a user and a merchant. The system comprises a memory location having (i) a transaction record indicative of the number of transactions between the user and the merchant, and (ii) a milestone associated with a reward provided by the merchant. The reward is applied upon the milestone being met by the user. The system further comprises a processor coupled to the memory location, wherein the processor applies a reward to a given transaction between the user and the merchant based upon a comparison between the transaction record and the milestone. In some situations, the processor is adapted to execute machine-readable instructions to implement a transaction between the user and the merchant. The transactions may include the user purchasing a product of service from the merchant, which purchase is made in exchange for money from the user to the merchant.

The system can facilitate payment from the user to the merchant. In an example, the system transfers funds to the merchant and receives funds from the user. The funds received from the user may be greater than or equal to the funds transferred to the merchant. In another example, the system transfers funds directly from the user to the merchant.

In some embodiments, the system is configured to initiate a transaction between the user and the merchant. In an example, the system initiates and facilitates the transaction between the user and the merchant if the user is within a given distance from the merchant. The distance can be based upon a determination of the geolocation of the user. For instance, a geolocation device of the user can determine the geographic information of the user, and direct the geographic information to the system. If the user is within a given (e.g., predetermined) distance from the merchant, the system can permit the user to initiate a transaction with the merchant (e.g., open a tab). In some situations, the user's geolocation device, upon determining that the user is within a given distance from the merchant, permits the user to initiate a transaction with the merchant with the aid of the system.

### EXAMPLES

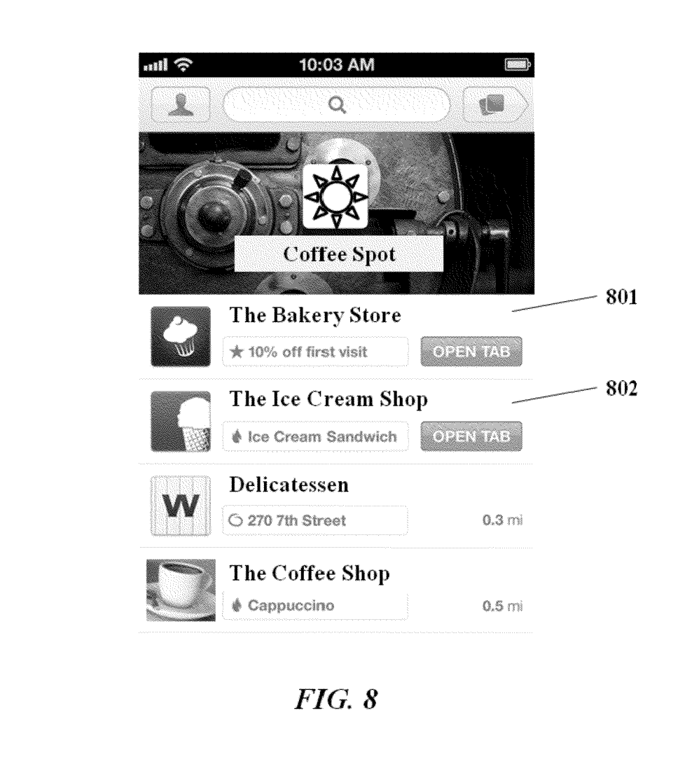

FIGS. 8-25 show example screenshots of graphical user interfaces (GUI's) of applications (apps) on display on an electronic device (e.g., mobile device) of a user. The electronic device may include, for example, a passive screen, a capacitive touch screen, or a resistive touch screen. The electronic device can include a network interface and a browser that enables the user to access various sites or locations on an intranet or the Internet. The app is configured to enable the mobile device to communicate with a server, such as the server 201 of FIG. 2, which facilitates a transaction between the user and a merchant.

FIG. 8 shows example results of a search around a geolocation of the user. The GUI includes, in list view (or “directory view”), a merchant card and a featured merchant (“Coffee Spot”). The merchant cards for The Bakery Store and The Ice Cream Shop include widgets 801 and 802 that include content dynamically tailored to the user. The content of each widget 801 and 802 includes a discount or other promotion provided by a merchant relevant to the user. For example, The Bakery Store has offered the user 10% off on the user's first visit to The Bakery Store. The merchant cards may be sorted on the basis of relevance criteria, as described elsewhere herein. The cards of FIG. 8 are ranked on the basis of relevance to the user, as determined, for example, based on how frequently the user visits a merchant. In the illustrated example, the system has determined that the user is a first time payer at The Bakery Store and frequently purchases from The Ice Cream Shop. The system provides The Bakery Store and The Ice Cream Store cards at the top of the list in the illustrated directory. In some cases, relevance can be determined on the basis of a single factor (e.g., user is a first-time payer, the user is a frequent payer), or a balance of multiple factors, such as proximity to a user and whether the user is a first time or frequent payer.

In some situations, merchant cards are ranked or otherwise sorted based on what the system or a merchant considers being most useful to the user. For example, the system may maintain a record of the user's buying and spending habits, and with the aid of a predictive model predict what the user may need at a given point in time. Merchant cards may then be sorted based on the predictive model.

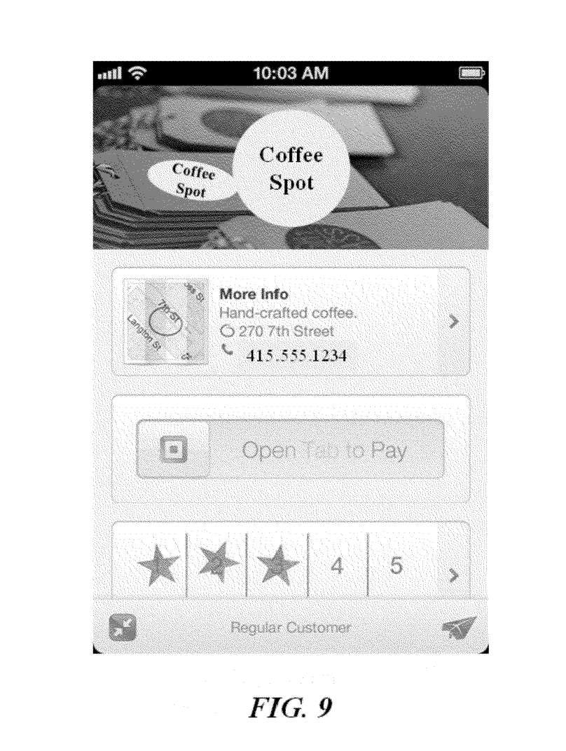

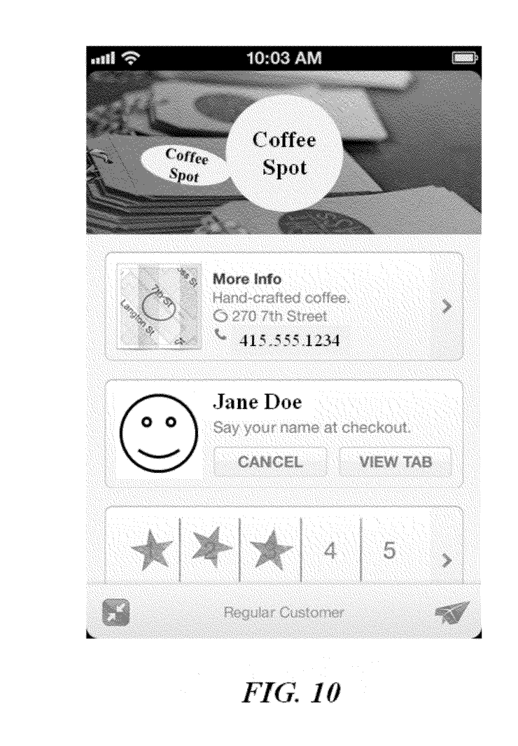

The user may select a merchant card for more information on a particular merchant. In FIG. 9, the user selects the Coffee Spot merchant card to view additional information on the Coffee Spot. The merchant card can include a location of the Coffee Spot and a brief overview of the Coffee Spot. The additional information may include loyalty and/or reward information relevant to the user. The GUI of FIG. 9 can enable the user to open a tab at the Coffee Spot, and presents the user a visual indication of the user's rewards punch card with the Coffee Spot. The punch card shows that the user needs two more qualifying purchases at the Coffee Spot to receive a reward from the Coffee Spot. The user (“Jane Doe”) can slide (or swipe) the Open Tab to Pay bar from left to right to access tab features, as shown in FIG. 10. Upon making a purchase at the Coffee Spot, the user may retrieve an item purchased at the Coffee Spot by providing the name or other identifying information of the user at the Coffee Spot.

Purchases by the user at a merchant that may qualify the user for a reward from the merchant, or points that may be accrued to receive a reward, may be graphically illustrated using various shaped elements (e.g., circle, triangle, box, rectangle, pentagon, hexagon, or star) and colors (e.g., red, blue, green, yellow). In FIG. 9, for instance, qualifying purchases at the Coffee Spot are marked by stars. The location of the stars may be offset in relation to a plane such that the stars appear randomized. In FIG. 9, the start for the second visit is vertically offset from the starts for the first and third visits. The locations of stars (or other objects) may be provided in row or column format. A punch car may include stars (or other objects or indicators) in row or column format, or a grid format. Alternative, stars may be precluded and the tally of the user's purchases in relation to a milestone may be displayed as a number (e.g., three out of five purchases).

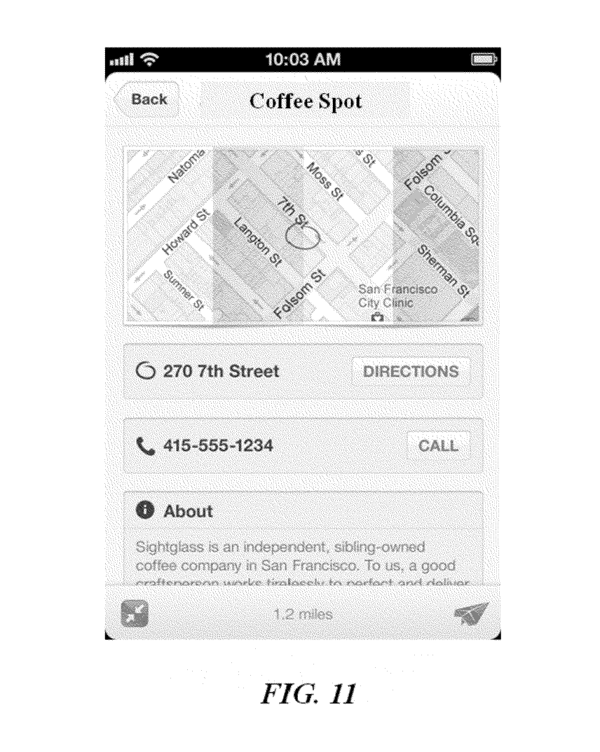

The GUI of FIG. 9 can enable the user to receive directions to the Coffee Spot. For example, the user can select More Info to view the location of the Coffee Spot in map view, as shown in FIG. 11. The additional information on the Coffee Spot also includes the address and phone number of the Coffee Spot, and a description of the Coffee Spot (under “About”). The GUI of FIG. 11 displays the distance of the Coffee Spot from the geolocation of the user (1.2 miles in the illustrated example), or the geolocation of the user. Under map view, the user may zoom in for additional features and functionality, such as to view further details of a select area.

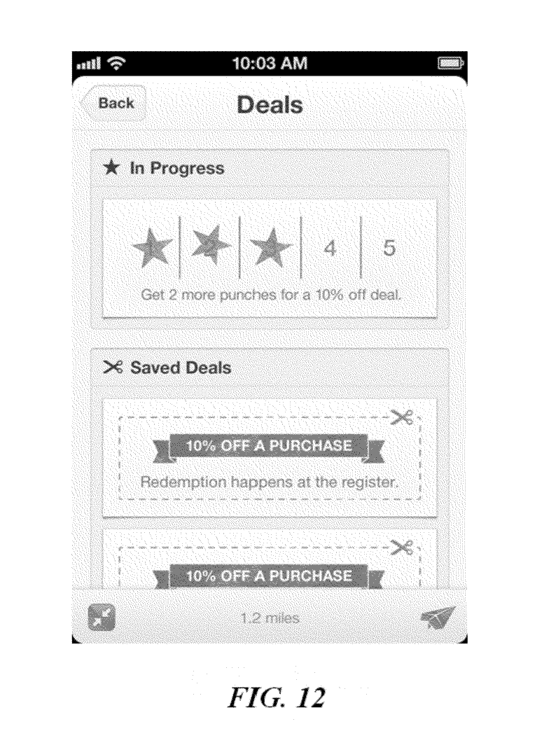

The user may select the rewards punch card (also “graphical punch card” herein) to access additional details on any rewards offered by the Coffee Spot. Selecting the rewards punch card at the bottom of FIG. 10, for instance, provides additional details on the reward, as shown in FIG. 12. The details may include the progress of the reward, and a promotional offer or deal that may be provided to the user upon meeting a reward milestone. In FIG. 12, the details are tailored for the user and display that the user has received three stars and has two more stars to go until the user is able to receive a 10% discount from the merchant. In addition, the user is able to save deals for future redemption. In the illustrated example, the user has saved “10% OFF A PURCHASE” deals to be redeemed at a future point in time. Other deals may be from be retrieved from a punch card or other promotion. The user may redeem a saved deal (or promotion) by selecting the deal from the GUI.

Rewards and deals may have an expiration date that is set by the system or the merchant. In some cases, a reward may not have an expiration date. A merchant may authorize the system to provide a select number of rewards or deals. In addition, saved rewards can be ranked and sorted based on one or more relevance criteria, which may be dependent on the user's lifestyle factors, including spending habit. A most recently saved card may appear at the top of a list or other graphical representation (e.g., carousel view) of saved cards.

In some embodiments, saved cards can be ranked or otherwise sorted in view of the user's lifestyle factors, such as the user's eating habits, drinking habits, hobbies, exercise routines, sports activities, sleeping habits, work habits, habits of significant others, and/or other factors that may be relevant to the user's lifestyle or living condition.

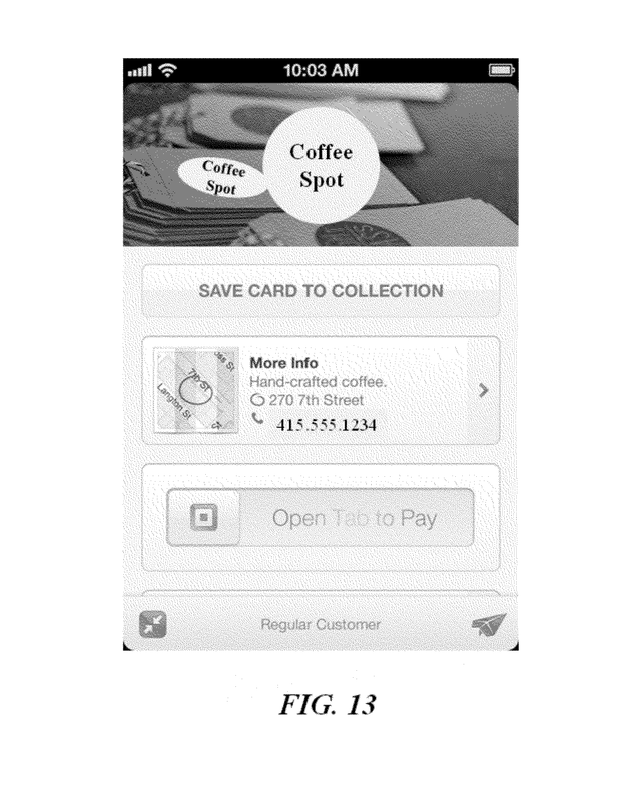

Users may save cards for future use. In FIG. 13, the user has selected the Coffee Spot card from the GUI of FIG. 8, and the app, upon determining that the card is not saved in the user's profile, provides the user the opportunity to save the card (“SAVE CARD TO COLLECTION”). The card of FIG. 13 may enable the user to open a tab with the Coffee Spot to pay for a product selected by the user.

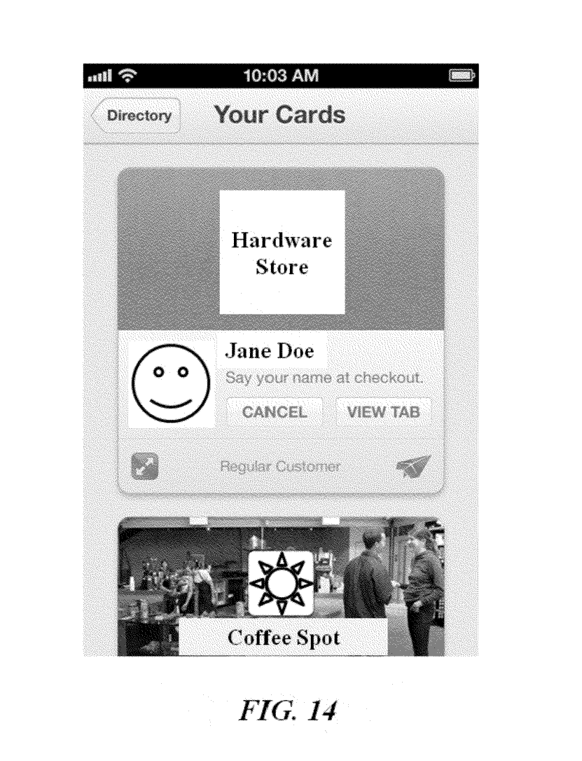

Users may view merchant cards in list view (see, e.g., FIG. 8) or carousel view. FIG. 14 shows merchant cards in carousel view. The user can view cards by swiping a finger of the user across a display of the electronic device of the user either from top to bottom or bottom to top, depending on which cards the user wishes to view. A merchant card in carousel view may include additional information about the merchant and/or the user which may not be provided in list view. For example, the Hardware Store card of FIG. 14 indicates that the user is a regular or repeat customer (“Regular Customer”) at the Hardware Store. The user can swipe from left to right (or right to left) within a widget to show different content. In some examples, in carousel view, the user can swipe along a first direction (e.g., top-to-bottom, bottom-to-top, diagonally from bottom to top, diagonally from top to bottom) to browse merchant cards, and swipe along a second direction that may be angled (e.g., orthogonal) to the first direction to view additional information about a given merchant. The user can swipe diagonally across a given merchant card.

In some cases, swiping along the second direction can enable the user to access other features and functionalities, such as accessing another carousel or merchant directory.

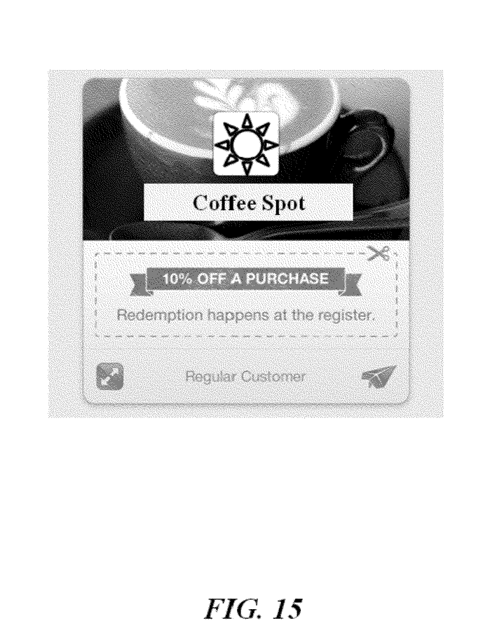

FIG. 15 shows a Coffee Spot merchant card, which may be provided on the GUI in carousel view. The card indicates that the user may receive a discount (“10% OFF A PURCHASE”) upon making a purchase at the Coffee Spot, which may be redeemed at the register of the Coffee Spot. The card also indicates that the user is a regular or repeat customer at the Coffee Spot.

From a merchant card, the user may access one or more products or services offered by a given merchant for purchase using the system. Selecting The Bakery Store on the GUI of FIG. 8 can provide the user with various merchant menu items for purchase. The menu items may be provided by the merchant to the server, or directly provided by the merchant to the electronic device of the user.

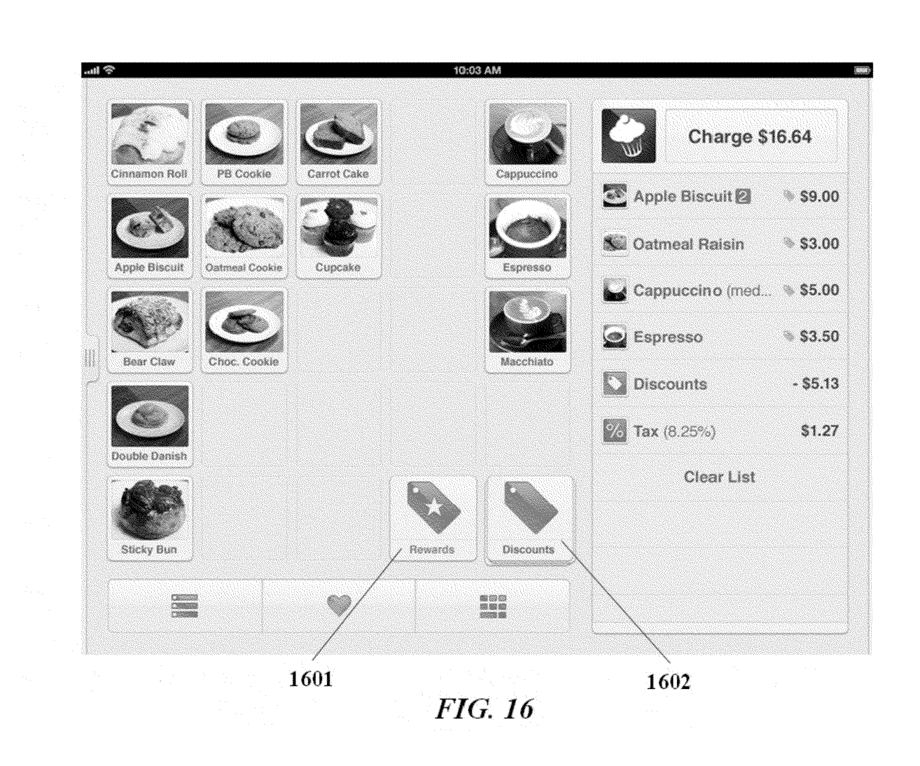

FIG. 16 shows an example display of menu items (e.g., on a Merchant Device). In an example, a Merchant Device of the merchant is at a point of sale (e.g., register) of the merchant. The user (e.g., merchant, payer) can select one or menu items from the area on the left for purchase. The area on the right shows menu items selected for purchase in a transaction. In the illustrated example, the user has selected menu items totaling $16.64, which takes into account a $5.13 discount provided to the user. The discount may be provided on the basis that the payer is a repeat customer, or other promotional deal, such as if the user is a first-time buyer or located a given distance from The Bakery Store.

The system, through app, may permit the user to determine whether the user is able to redeem any rewards or qualify for other promotions. The GUI of FIG. 16 provides a rewards link 1601 and a discounts link 1602. The user can select the rewards link 1601 to view any rewards that may be applied to the transaction. The user can select the discounts link 1602 to view any discounts that may be applied to the transaction.

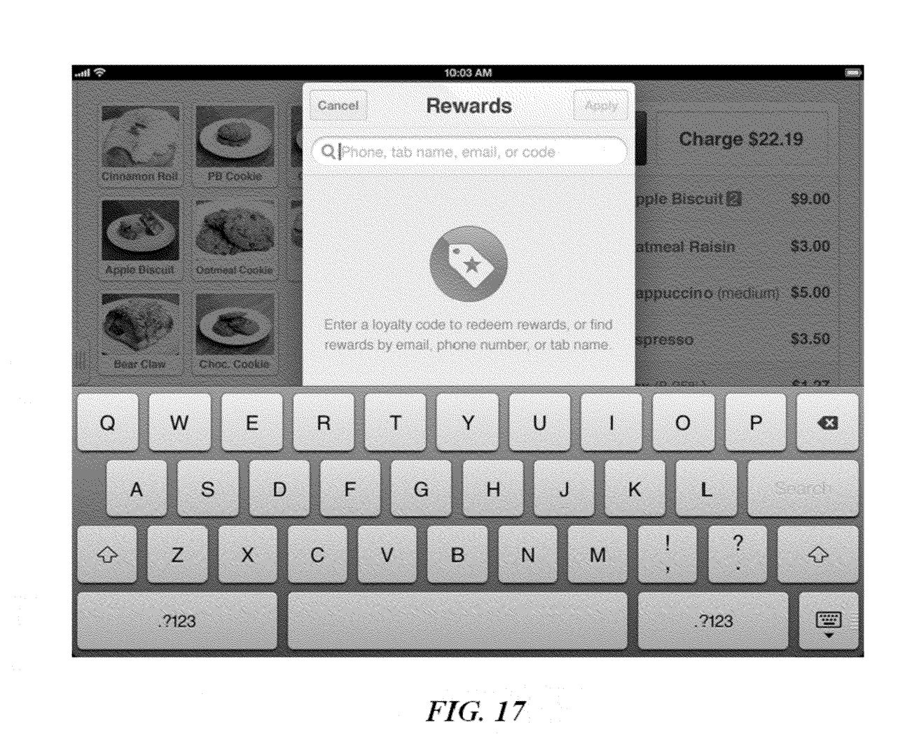

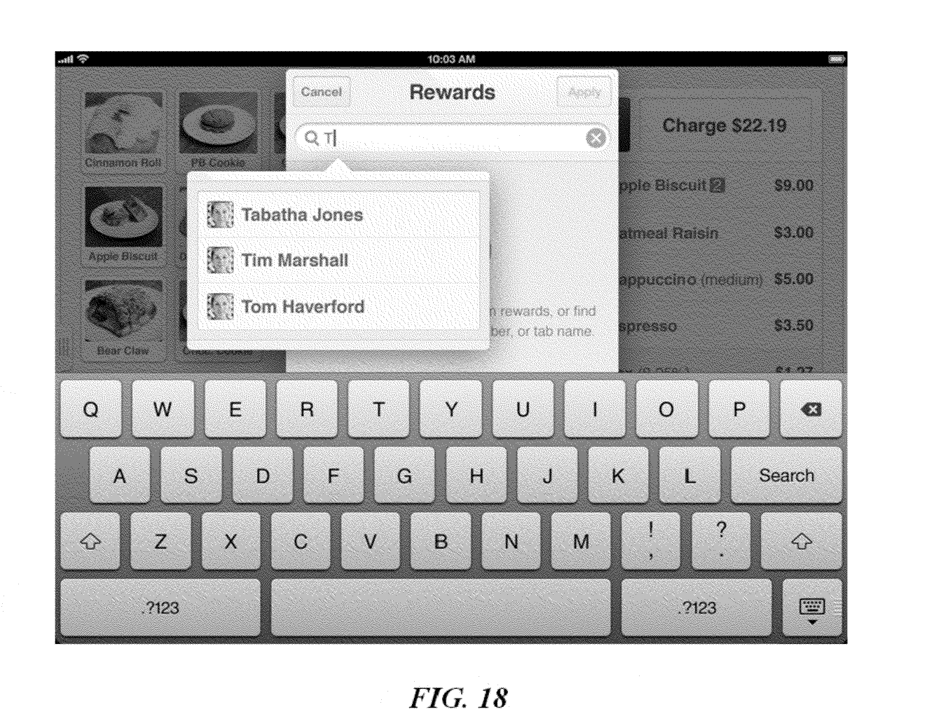

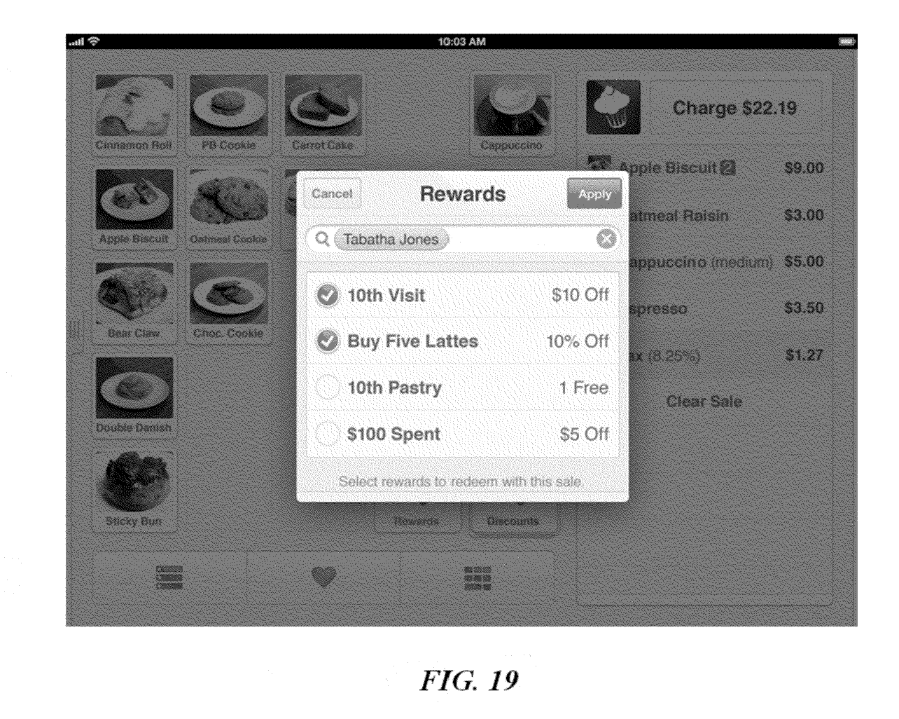

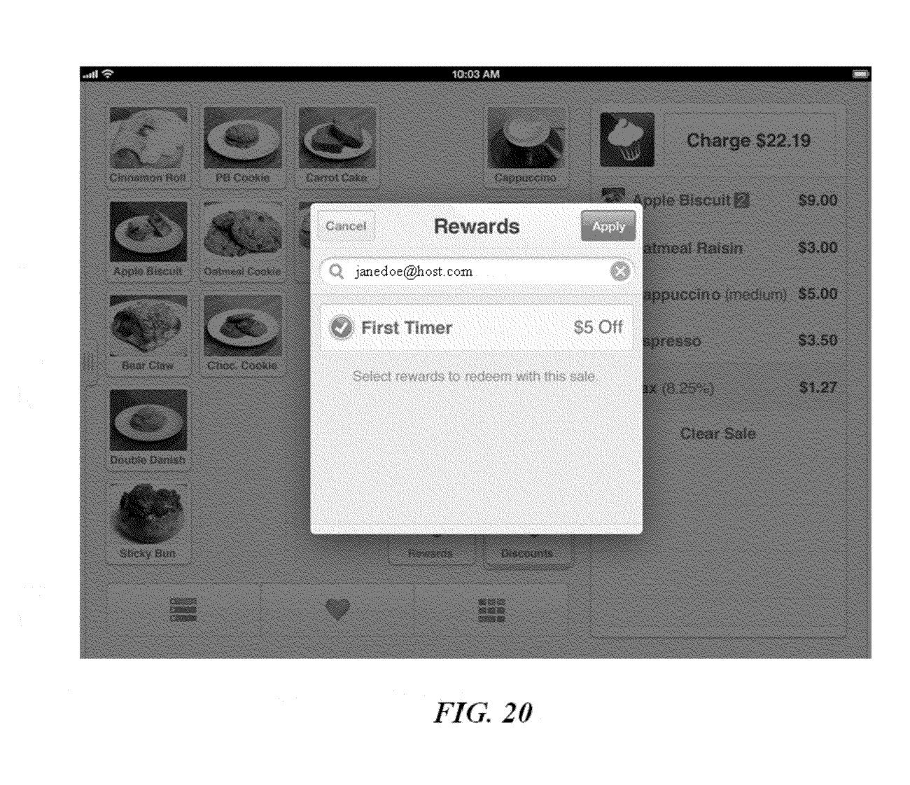

Selecting the rewards link 1601 brings the user to a rewards search box, as shown in FIG. 17. The search box can permit the user to enter a unique identifier (e.g., phone number, tab number, email) or other code. The system can then conduct a search for rewards that may be available for use by the user based on the search. With reference to FIG. 18, the user begins entering a name, and the app attempts to estimate the name of the user and suggests auto-complete options. In FIG. 19, the user has entered a name, which may be the name of the user, and the system has provided the user potential rewards that may be redeemed (i.e., applied to the transaction of FIG. 16). The user may or may not choose to use all possible rewards, but may save at least some for future use. The use may elect rewards or other deals that the user wishes to use in the present transaction, such as by selecting an appropriate check box. In the illustrated example, the user has selected to redeem the $10 off reward (for completing the milestone “10th Visit”) and 10% off reward (for completing the milestone “Buy Five Lattes”). As an alternative to conducting a name search for rewards, the user may enter an electronic mail (email) address. FIG. 20 shows the result of a search (“$5 Off” for being a “First Timer”) directed at an email address.

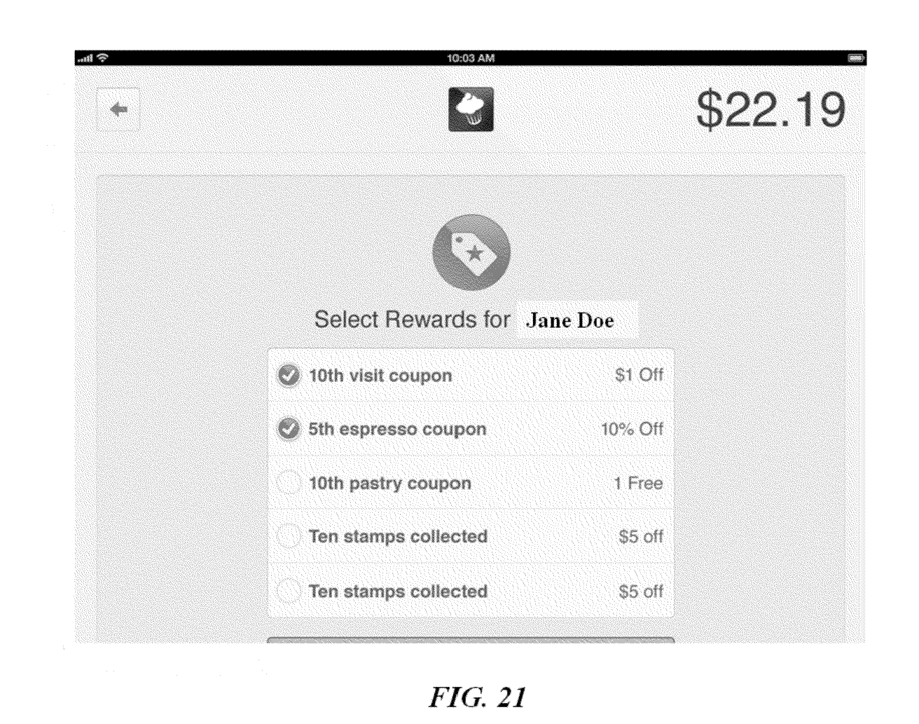

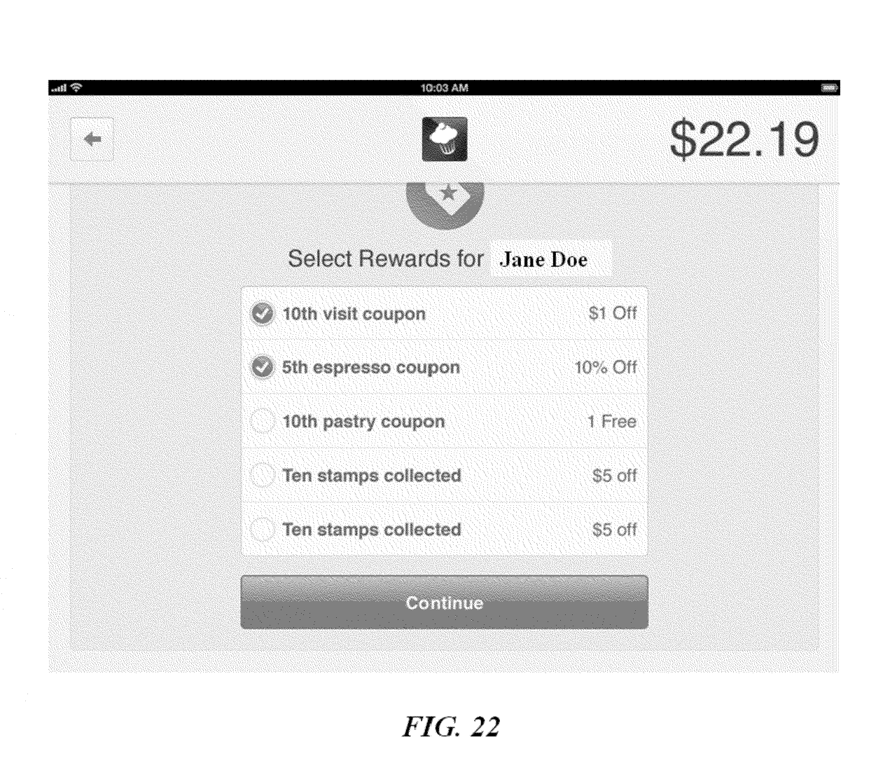

With reference to FIGS. 21 and 22, the user selects various rewards to be applied to a transaction with a merchant and payer (“Jane Doe”). In the illustrated example, the user has selected a 10th visit coupon and a 5th espresso coupon to apply. The user can scroll or swipe up or down to access various portions of the GUI. The user may select “Continue” to continue the transaction with the applied rewards.

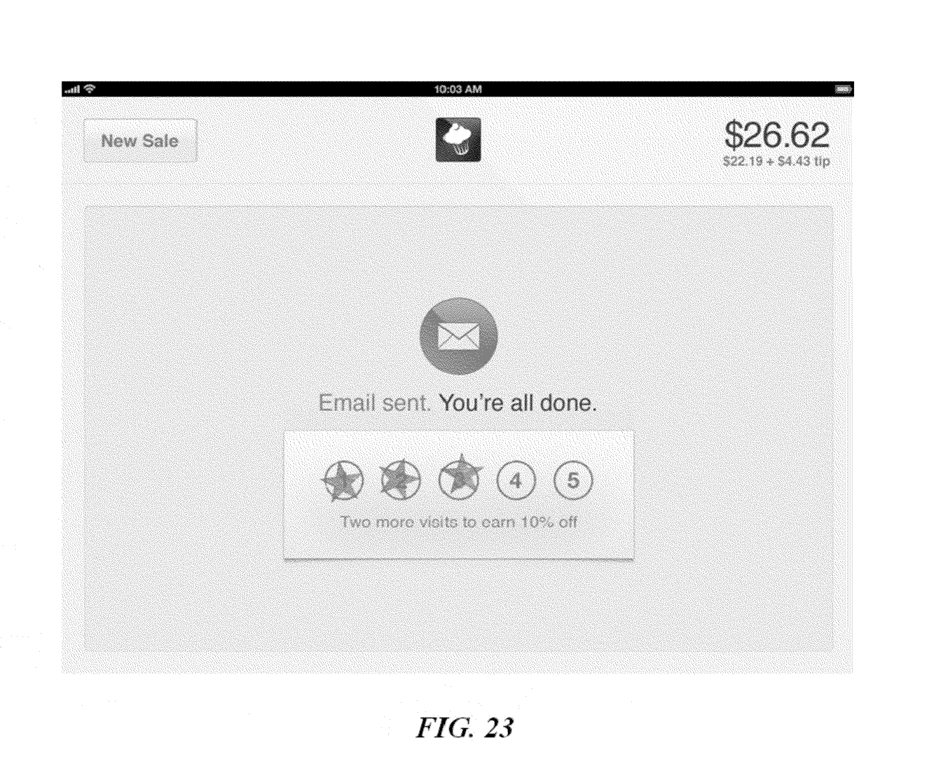

Upon completing a transaction, the system can provide the payer user with an electronic receipt. The electronic receipt can be submitted by a channel chosen by the payer (e.g., via email, SMS, printed receipt, etc.) FIG. 23 shows a confirmation screen that shows that transaction is completed and an electronic receipt has been directed from the system to the payer user by email. The screen can also show an update on the user's rewards punch card with the merchant. The screen indicates that the user has two more visits to receive a discount (“10% off”) at a future transaction. The screen shows the total spent on the transaction, which includes $22.19 plus a tip amount of $4.43.

In some cases, the user in the illustrated examples of FIGS. 16-23 is a merchant, and the merchant is inputting an order for a payer. In other situations, however, the user can be a payer that is inputting an order remotely or at a location of the merchant. Input can be provided through the Merchant Device or an electronic device of the payer (“Payer Device”).

In some examples, the GUI of FIGS. 16-23 is displayed on the Merchant Device of the merchant. The merchant can select one or more items for purchase by the payer from a menu of the merchant (see, e.g., FIG. 16). On the Merchant Device the merchant can select the rewards link (e.g., link 1601) to search for one or more rewards to provide the payer and apply one or more rewards to the transaction (or a future transaction) between the merchant and the payer, and/or a discounts link (e.g., link 1602) to search for and apply one or more discounts (or other promotions). Alternatively, the merchant can provide the payer access to the Merchant Device to select one or more items for purchase by the payer from the merchant. In an example, the merchant provides the Merchant Device to the payer, and the payer directly interacts with the Merchant Device. The payer can return the Merchant Device to the merchant for additional information or to complete the transaction. In another example, the Merchant Device is provided in a self-checkout setup (e.g., self-checkout kiosk), which can permit the payer to select menu items and complete a transaction using the Merchant Device without having to directly interact with the merchant. A reward search box (see, e.g., FIG. 17) can permit the merchant to input identifying information of the payer, such as the payer's name, email address, phone number, and/or tab number, and the system can then provide the merchant any rewards that the payer may be able to redeem at the merchant. In some cases, the merchant can input identifying information of the merchant into the Merchant Device, such as into a rewards search box or a promotions search box, and the system can display one or more rewards or promotions that can be applied to the transaction between the payer and the merchant. Promotions can include deals, discounts, and/or items (or services) of value that can be provided by the merchant to the payer.

In some examples, the GUI of FIGS. 16-23 is displayed on the Payer Device. On the Payer Device the payer can select one or more items for purchase from a menu of the merchant (see, e.g., FIG. 16). The payer can select a rewards link (e.g., link 1601) to search for one or more rewards to be used in the transaction with the merchant and apply one or more rewards to the transaction (or a future transaction), and/or a discounts link (e.g., link 1602) to search for and apply one or more discounts. A reward search box (see, e.g., FIG. 17) can permit the payer to input identifying information of the payer into the GUI of the Payer Device, such as the payer's name, email address, phone number, and/or tab number, and the system can then provide the payer any rewards that the payer may be able to redeem at the merchant. In some cases, the reward search box can permit the payer to input identifying information of the merchant, and the system can display one or rewards that can be applied to the transaction between the payer and the merchant. In some examples, the payer can provide the merchant access to the Payer Device, and the merchant can select one or more items for purchase by the payer, input a promotional or discount code into the Payer Device, and/or input identifying information into the Payer Device for a reward to be redeemed by the payer.

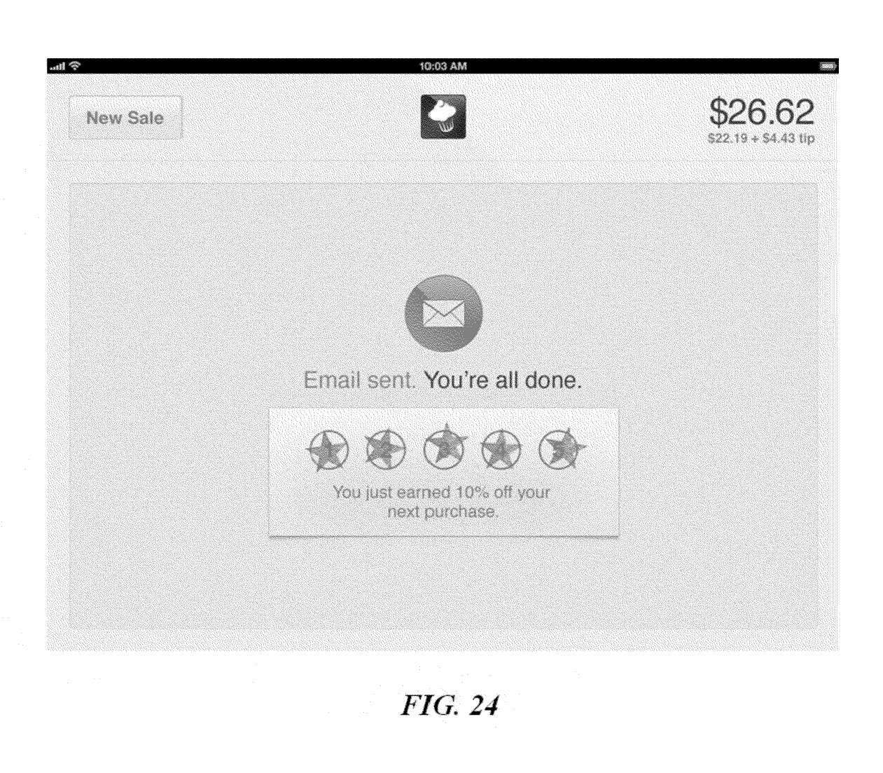

With reference to FIG. 24, the user has completed a transaction at a merchant, and the user's punch card indicates that the user has earned a discount for the user's next purchase (“10% off your next purchase”). The punch card in such a case can be saved as a coupon or reward for future use. In some cases, the server can save a coupon or reward associated with the payer user account that can be used at the merchant.

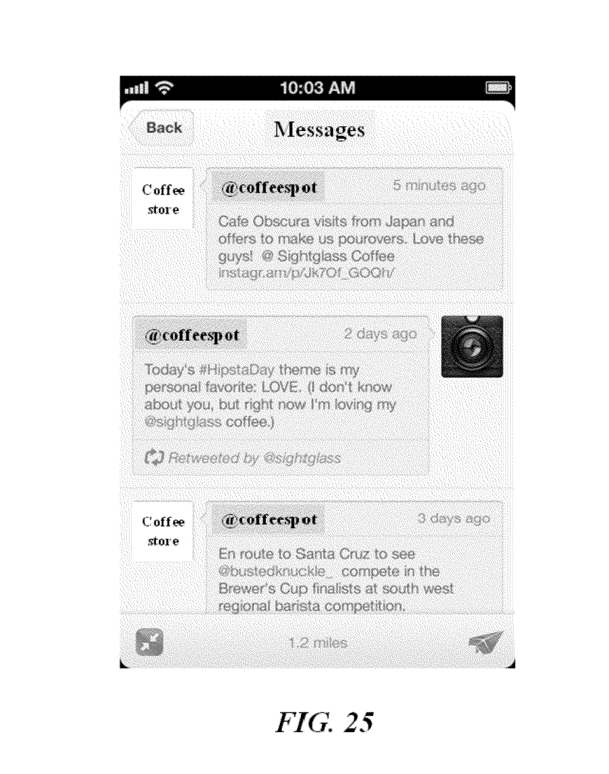

FIG. 25 shows electronic messages (e.g., email message, Twitter® message, Facebook® status updates or messages, Google+® messages, instant messages) from certain merchants to the user. The messages may include deals or suggestions to the user.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

1. A computer-implemented method for processing a transaction between a user and a merchant, comprising:
(a) receiving a request from said user to conduct a transaction with said merchant, wherein said request is received by a computer system programmed to facilitate said transaction;
(b) processing, with the aid of a processor of said computer system, the transaction between said user and said merchant; and
(c) updating a rewards database of said computer system with a record of the transaction processed in (b), wherein the rewards database includes a history of one or more transactions between the user and the merchant and a milestone that must be met for the user to be provided a reward from the merchant.

2. The method of claim 1, wherein said request of (a) is received from an electronic device of said user.

3. The method of claim 2, wherein said electronic device is a portable electronic device.

4. The method of claim 1, wherein, upon receiving said request in (a), said rewards database is accessed to identify said reward.

5. The method of claim 4, wherein said computer system applies said reward to said transaction if the computer system determines that the milestone has been met.

6. The method of claim 5, wherein, in (b), said transaction is processed with said reward applied to said transaction.

7. The method of claim 1, wherein said merchant is at or in proximity to a geolocation of said user.

8. The method of claim 7, wherein said geolocation is determined with the aid of a geolocation device of said user.

9. The method of claim 8, wherein said request is received from said geolocation device.

10. The method of claim 1, further comprising (d) displaying on an electronic device of said user the status of said reward based upon the rewards database updated in (c).

11. A computer-implemented method for providing a reward to a user in connection with a transaction between said user and a merchant, comprising:
updating a rewards database of a computer system with a record of a transaction between a user and a merchant, which rewards database includes a history of one or more transactions between the user and the merchant and a milestone that must be met for the user to be provided a reward from the merchant,
wherein said transaction is (i) initiated upon receiving, by a computer system programmed to facilitate said transaction, a request from said user to conduct said transaction with said merchant, and (ii) processed with the aid of a processor of said computer system.

12. The method of claim 11, wherein said request is received from an electronic device of said user.

13. The method of claim 12, wherein said electronic device is a portable electronic device.

14. The method of claim 11, wherein, upon receiving said request, said rewards database is accessed to identify said reward.

15. The method of claim 14, wherein said computer system applies said reward to said transaction if the computer system determines that the milestone has been met.

16. The method of claim 15, wherein said transaction is processed with said reward applied to said transaction.

17. The method of claim 11, wherein said merchant is at or in proximity to a geolocation of said user.

18. The method of claim 17, wherein said geolocation is determined with the aid of a geolocation device of said user.

19. The method of claim 18, wherein said request is received from said geolocation device.

20. A computer-implemented method for processing a transaction between a user and a merchant, comprising:
displaying, on an electronic device of a user, a status of a record of one or more transactions with a merchant against a milestone that must be met for the user to be provided a reward from the merchant,
wherein said one or more transactions are (i) initiated upon receiving, by a computer system programmed to facilitate said transaction, a request from said user to conduct said transaction with said merchant, and (ii) processed with the aid of a processor of said computer system.

21. The method of claim 20, wherein said request is received from said electronic device of said user.

22. The method of claim 21, wherein said electronic device is a portable electronic device.

23. The method of claim 20, wherein said status is displayed on said electronic device of said user upon updating a rewards database of said computer system with a record of a given transaction among said one or more transactions.

24. The method of claim 23, wherein said rewards database includes a history of one or more transactions between the user and the merchant and said milestone.

25. The method of claim 23, wherein, upon receiving said request, said rewards database is accessed to identify said reward.

26. The method of claim 25, wherein said computer system applies said reward to said transaction if the computer system determines that the milestone has been met.

27. The method of claim 26, wherein said transaction is processed with said reward applied to said transaction.

28. The method of claim 20, wherein said merchant is at or in proximity to a geolocation of said user.

29. The method of claim 28, wherein said geolocation is determined with the aid of a geolocation device of said user.

30. The method of claim 29, wherein said request is received from said geolocation device.

31.-42. (canceled)
